(19) United States
(12) Patent Application Publication
(10) Pub. No.: US 2014/0333998 A1
(43) Pub. Date: Nov. 13, 2014

(54) MICRO-LENS FOR HIGH RESOLUTION MICROSCOPY

(71) Applicant: Board of Trustees, Southern Illinois University, Carbondale, IL (US)

(72) Inventors: Punit Kohli, Carbondale, IL (US); Ramiah Rajasekaran Pradeep, Gainesville, FL (US); Chuanhong Zhou, Carbondale, IL (US)

(73) Assignee: BOARD OF TRUSTEES, SOUTHERN ILLINOIS UNIVERSITY, Carbondale, IL (US)

(21) Appl. No.: 14/206,644

(22) Filed: Mar. 12, 2014

Related U.S. Application Data
(60) Provisional application No. 61/777,731, filed on Mar. 12, 2013.

(51) Int. Cl. G02B 21/02; G02B 21/00; G02B 21/26

(52) U.S. Cl. CPC G02B 21/02; G02B 21/26; G02B 21/0044; Y10S 977/881; B82Y 35/00
USPC 359/391; 359/368; 977/881

(57) ABSTRACT

A method and apparatus for nanoscopy comprising a salt microlens. The microlens-based nanoscope comprises a conventional microscope, a microlens, and a XYZ piezoelectric stage is shown (SEE FIG. 1A). The microlens is mounted on a Z-stage and can be driven to accomplish the scanning. The specimen is placed above the microlens which is a plano-convex lens. The set up employed for the Salt Microlens for Ultra-high Resolution Imaging (SAMURI) can use a halogen-tungsten lamp with a dominant wavelength at 600 nm. A magnified virtual image of the specimen is obtained when the distance between microlens and specimen is less than the focal length of the microlens. The virtual image can then be magnified by the microscope and captured by eyes or a CCD camera.

### BACKGROUND OF INVENTION

1. Field of Invention

The present invention relates to ultra-high resolution microscopy for viewing microscopic and nanoscopic features. More specifically, the present invention relates to an optical design which provides high contrast and sharp images, providing for higher detail.

2. Background Art

Microscopes have been utilized by scientists and researchers for hundreds of years to observe items that are microscopic in size and not readily viewable by the human eye. From chemistry to the construction of computer chips to genetics to medical research, nearly every imaginable discipline has benefited from the ability to magnify items for viewing and observation.

The oldest of microscopes were optical in nature, and were comprised of little more than a few lenses and a light source. These microscopes use the visible wavelengths of light to observe the microscopic object. Over time, such optical microscopes have become more and more complex using dozens of lenses and reflecting/refracting elements. Medical researchers often use optical microscopes, as they allow living specimens to be observed without causing harm to the specimens. Today, such optical microscopes are considered to have a “theoretical limit” of resolution of about 200 nanometers—because of the resolution limitations of lenses and their index of refraction, the limited wavelengths of visible light, and limitations on the angular apertures of lenses. Thus, things smaller than approximately 0.2 microns are not readily viewable through standard optical microscopes. Even when viewing features at this lower resolution limit, some contrasts and color are often lost.

The scanning electron microscopy (SEM), the transmission electron microscopy (TEM), the scanning tunnel microscopy (STM), and the atomic force microscopy (AFM) extended human's vision down to nanometer scale. As one of the oldest microscopic techniques, optical microscope still has significant applications. Optical microscopes are easy-to-use, non-invasive, environment-friendly and inexpensive. They are extensively used in diverse areas and more than 80% microscopic studies relied on optical microscope in the life science.

Optical microscope is principally an imaging apparatus based on diffraction. The diffractive light waves from objects are picked up by the objective and interfere with each other to produce contrastive images. Since the higher diffractive order carries smaller feature information of objects, the resolution of image is decided by the highest diffractive order collected by the objective. Therefore, the resolution limit due to diffraction is referred to as diffraction limit. In general, a wide-field optical microscope cannot resolve two points that are <200 nm apart. With fluids having higher refractive index (n), resolution (dₛ)can be further increased but usually these fluids are highly toxic or flammable in nature.

More recent developments in microscopy have resulted in electron microscopes, which use beams of electrons instead of beams of light. As electrons can be accelerated to produce a much smaller wavelength than visible light, electron microscopes allow much higher resolution than standard optical microscopes.

However, while electron microscopes can resolve features less than 0.2 microns, they typically cannot be used on living specimens. Electron microscopes use very high energy electron beams which can be harmful to living specimens. Also, to be viewed by an electron microscope, each specimen must be placed in a vacuum for viewing, as a gas would improperly scatter the electron beam, which vacuum would cause the death of a living specimen. Further, electron microscopes are often quite expensive to purchase and maintain, and require special power sources and a stable building.

Therefore, it would be preferable to combine the higher resolution qualities of an electron microscope with the lower expense and the ability to view living specimens of an optical microscope. It would further be preferable to view true color and high contrast images through an optical microscope.

Many efforts have been made to extend the ability of optical microscope to explore the realm below 200 nm. These efforts can be classified into three categories: First group is to enhance the unresolved images by making a de-convolution operation with a specific point spread function of the imaging system. The second method involves collecting more spatial harmonics of scattering light, even evanescent waves, into the imaging process. Examples include the large numerical aperture lens (oil immersion lens and solid immersion lens), structural microscope, negative refraction lens, hyperlens, surface plasmonic lens, super oscillation lens and near-field scanning optical microscopy (NSOM). These techniques however face challenges of unavoidable losses or extreme fabrication finesse with multiple steps. Furthermore, some of these methods work in near field mode, or placing the lens on the surface of the objects, or require special hardware such as illumination source (lasers with particular beam shape). The last is based on the control of the interaction of light with matters (stimulated Emission Depletion (STED) microscopy, stochastic optical reconstruction microscopy (STORM), and photo-activated localization Microscopy (PALM) techniques). These methods have enhanced the imaging resolution, they also require complex/expensive instrumentation such as picoseconds lasers (STED and confocal microscopy), or demand special fluorophores (STROM/PALM) for enhancing the resolution.

### BRIEF SUMMARY OF INVENTION

An optical nanoscope is disclosed and claimed herein that can resolve features below 100 nm through the use of deliquescent-salt based microlenses. The nanoscopy is shown to break the diffraction limit and provides magnification between ×2 and ×6 in a conventional microscope using white light illumination. The method of achieving super-resolution is inexpensive and easy to operate in atmospheric conditions. Any conventional optical microscope can be easily converted into a super-resolution nanoscope by incorporating the proposed high-resolution microlens. The fabrication of the lens is extremely simple, highly reproducible with high yield, and an array of lenses can be self-assembled in a wet-lab without any need for clean-room facilities. With the imaging nanoscope as disclosed and claimed herein, the scientists will be able to probe under environmental conditions the biological particles, large biomolecules, and static and dynamic processes at/near cell surface at super-high resolution.

The noninvasive microscope uses liquid plano-convex microlens (ML) to collect diffractive light from specimen. The deliquescent salt added in the liquid maintains the atomic smooth surface and the high refractive index of microlens. The microlens works in the near proximate to the objects and picks up both propagation and evanescent light diffracted from the objects. The produced super-resolution and enlarged images are then magnified by the conventional microscope. The microscope provides superior resolution for fluorescence imaging where a resolution of ˜90 nm and ˜4 enhanced emission intensity was obtained. This microlens based microscope is easy to fabricate and use, inexpensive and no special requirement to illumination. It has potential applications in diverse fields of life-, bio-, and nano-sciences.

The microlens-based nanoscope comprises a conventional microscope, a microlens, and a XYZ piezoelectric stage (FIGS. 1A and 1B). The microlens is mounted on a Z-stage and can be driven to accomplish the scanning. The specimen is placed above the microlens which is a plano-convex lens. FIG. 1B shows the set up employed for the Salt Microlens for Ultra-high Resolution Imaging (SAMURI) using halogen-tungsten lamp with a dominant wavelength at 600 nm. A magnified virtual image of the specimen is obtained when the distance between microlens and specimen is less than the focal length of the microlens. The virtual image can then be magnified by the microscope and captured by eyes or a CCD camera or other sensor or receptor device. For achieving high quality images, the microlens-specimen and microlens-objective distances can be carefully adjusted. They can be adjusted by the Z-stage and focus knob of the microscope.

Regarding the fabrication methods of the deliquescent-salt microlenses, the nanoscopy system disclosed and claimed herein, includes a microlens, which is a component of the nanoscope. A new method as disclosed and claimed herein is utilized to fabricate microlenses by using delinquent salt solutions. The salt solution can be composed of deliquescent salts (such as CaCl₂ and ZnCl₂) and water. The deliquescent nature of the salts maintains an optically smooth surface without any further processing. The microlenses can be fabricated by using two approaches: One method used as disclosed herein involves printing the microlenses using a micropipette (FIGS. 2A-2G). The diameter of the pipette can be controlled between 100 nm to 10 μm using pulling parameters. The pipette is easily filled with salt solution due to capillary force and is used for printing lenses on functionalized glass. The size of the lens can also be controlled by choosing different sized dip pen, by adjusting the writing time, and using different solution concentrations.

A second approach utilizes the self-assembly process and is shown in FIG. 3. One method includes making a pattern on a glass slide in which an array of hydrophilic spots is surrounded by a hydrophobic surface. This is accomplished by coating the glass with a thin layer of spiropyran (SP) through a mask (FIGS. 3A-3D). SP is a well-known class of photochromic molecules that undergo a reversible photocleavage of C—O bond from a closed-ring (SP) to an opened-ring structure (merocyanine, MC). [25,26] MC is significantly more polar than SP, and can be highly stabilized using metal-MC complexation. This is the basis of formation of stable MC-metal ion complex. The patterned SP film can then be used as a template for the formation of microlenses. The aqueous salt solution selectively stays in the hydrophilic regions because of stabilization of MC with water molecules and metal ions. Because SP is hydrophobic, salt water solution prefers to stay in the hydrophilic area. Due to surface tension at the water-air interface, the plano-convex shape of the lens is formed. The lenses are stable for more than 3 months when kept in a high relative humidity (RH) environment.

The drying of the lenses was also observed when they were kept at a very low RH (<20%). However, optically smooth lenses were recovered after keeping them in high RH atmosphere. Unlike, NSOM and AFM tips which can easily break when in contact with an object, the microlenses do not break but deform when they touch a specimen. In order to prove the viability of the technology, the same microlens was used many times even after multiple microlens-specimen contact without losing its resolution and magnification characteristics. It is also possible to transfer the lenses to another glass with contact between the two glass substrates. One embodiment of the process can even control the transferred amount by controlling the contact area of the lens with new glass substrate. This method can provide smaller “daughter” microlenses from larger “mother” lenses.

Yet another implementation of the microlens can be construction of epoxy and glass microspheres (MO-SCI, Borosilicate Glass Spheres, r=19 μm). It is constructed using an imprint lithographic method to make the microlens (ML) array. The imprint lithographic method is easy to operate and very efficient. A TEM meth grid can be utilized as a template. The TEM mesh has a square lattice of square holes in stainless steel sheet with a lattice constant of about 50 μm and width of holes of about 25 μm (FIG. 1B). Then the epoxy (LOCTITE Epoxy, Resin and hardener 1:1; or other epoxy having similar characteristics) is uniformly spread on the TEM template and only left a tiny layer by scratching with a glass slide. The epoxy in the square holes forms a curved layer due to gravity. By impressing the TEM template on a glass slide, the epoxy in the holes is transferred to the glass slide. Because only the central parts of the curved layers of epoxy in holes contact the glass slide, the sizes of transferred epoxy on glass slide is much smaller than that of the holes. Also, the transferred epoxy takes spherical shape due to surface tension, where the diameter is about 5±3 μm. Monodispersed glass microspheres (MO-SCI, Borosilicate Glass Spheres, r=19 μm) can be placed on the patterned glass slide and blew it with nitrogen gas, so only those glued by epoxy array are retained on the glass slide (A3). Therefore, a microsphere array is formed on a glass slide.

A series of optical windows (wᵢ, blue structures) can be milled using a focused-ion beam (FIB) instrument on a 100 nm thick chromium-coated quartz substrate (grey in FIG. 1B). The widths (wᵢ) of four optical windows were (72±9) nm, (180±14) nm, (291±14) nm, and (394±31) nm (FIG. 1C). The separations (sᵢⱼ) between windows i and j were: s_{1,2}=(185±30) nm, s_{2,3}=(307±24) nm, and s_{3,4}=(414±28) nm. These nanostructures can be imaged under a conventional microscope with and without a KHgI microlens (diameter (D) and refractive index (η) of 18.6 μm and 1.71, respectively) kept ˜300 nm away from the optical windows.

The hemispherical delinquent-salt microlens based nanoscopy can achieve resolutions in the range of 60 nm using white light illumination without any significant modification to the microscope. Similar results can be attained with the glass epoxy configured microlense. Therefore, the disclosed microscope design can overcome the diffraction limitations encountered when using a conventional microscope, and can greatly enhance the optical resolution. The nanoscopic apparatus and method disclosed is simple, inexpensive, does not require complex/expensive instrumentation or fabrication processes, and the images can be obtained in atmospheric conditions. There is no need for significant hardware or software modifications to a basic microscope design to achieve the nanoscopic design. Bright-field, dark-field, phase-contrast, and fluorescence imaging can be achieved with a spatial resolution below the diffraction limit.

The salt-lens based and glass based microlense nanoscopy overcomes the diffraction limitation of conventional optical microscopy. The micro-lens can also include an array of multiple lenses. The disclosed design is simple, inexpensive, non-invasive, does not require complex/expensive instrumentation or fabrication processes, and the images can be obtained in atmospheric conditions. Therefore, the nanoscopy would find many potential applications in diverse fields including: life-, bio-, and nano-sciences and can help us with observing the nanoscale dynamics, processing and evolution in living biological materials. Further, the microlens has a nanoscale focal spot which makes the nanoscope suitable for observing fluorescence at nanoscale; the excitation energy can be focused at nanometer scale thereby reducing the excitation volume. The emission can be observed from the reduced focal spot using the same microlens. Since the nanometer scale focusing, the same setting is easy to use for nano scale nanolithography for printing of biomolecules (proteins, nucleic acid) and semi-conducting and information technology industry.

The refractive index of the lens may vary depending upon the moisture content in the atmosphere. Significant changes in the aperture Dr and refractive index n of the microlenses over time can affect their performance. In one embodiment, in order to minimize changes in Dr and n, a long fluorocarbon silane monolayer or a PDMS film can be deposited on the microlens. For the former, since the lenses contain water at the surface, a triethoxy group will be hydrolyzed at the surface. Care can be taken so that the silane reaction only occurs at the surface. This functionalization can enhance the mechanical stability of the lens and will act as a barrier to the moisture exchange between the lens and atmosphere. Fluorocarbons can also act as lubricants. For the PDMS film, a PDMS mixture was prepared using dimethyl siloxane and silicone elastomer and spin-coated on the glass substrate on which microlens/lens array are made. By controlling the spin speed and the amount of toluene solvent, the thickness of the PDMS film can be optimized to fit the use and protection.

Due to the spherical nature of the lenses, spherical aberrations in the images can occur because the image plane is not flat. In case, the spherical aberration is severe, a deconvolution operation on the images using an optical transfer function, aperture function and aberration of the lens can be utilized to minimize/eliminate the spherical aberration. Due to near-focusing phenomenon for generating super-high resolution images, the depth of focusing of the microlens can be ˜300-500 nm, in comparison to far-field imaging of ˜1-1.2 μm for λ=500-600 nm. This means that the depth of focus of the proposed imaging tool is comparable to a confocal microscope but much shallower than a convention far-field microscope. The proposed microscope can still be extremely useful in imaging static and dynamic biological processes near/on the surface of the cells, and in-vitro studies of very large biomolecules and particles (such as viruses and bacteriophages).

So the total magnification of nanoscope is the product of the two magnifications. The magnifications of MLs, just like other macro lenses, come from light refraction at the surfaces of MLs. Therefore, high magnification is accomplished by adopting high refractive MLs (with high refractive index and large curvature). Besides refraction, MLs have two other effects for getting even higher magnifications, i.e., focal length shortening and out-plane imaging.

Normally, the imaging of macro lenses is simply dominated by refraction. MLs have small Fresnel number (F˜7, F=D²/λf_{g}, D is aperture size of ML and f_{g} is geometric focal length) so that the diffraction from ML's edge is not negligible any more. The interplay of diffraction and refraction shift the focal point towards ML. It is demonstrated that the focal length f turns shorter with decreasing F. Therefore, the shortening f increases the magnification M according to M=(f/f−a), where a is ML-specimen distance.

Out-plane imaging provides another mechanism of magnification. Usually, the imaging quality was decayed very fast as the objective left off the image plane (FIG. 27 E-H). However, the out-plane images with ML maintained decent qualities by moving objective more than 10λ apart from image plane (FIG. 27 A-D). The out-plane magnification is simply understood by a divergent beam model: the cross section of a divergent beam is enlarged with propagation. So the magnification is estimated by (f+x)/f; where x is the distance of image to microlens. The high resolution of out-plane imaging was maintained by two factors: diffraction free imaging and divergence suppression. Since the out-plane imaging of ML belongs to virtual imaging, no real light involves thus no diffraction broadening spoils the imaging resolution. Secondly, the suppression of beam divergence helps maintain the resolution of out-plane imaging, which is achieved by using high refractive index and large curvature of ML: the divergent angle is squeezed by high refractive index according to Sell's law (n₀sin θ₀=n₁sin θ₁) and the large curvature of ML also decreases the beam divergence. Out-plane imaging provides an efficient way to enhance the magnification of MLs. As the shift is larger than 15λ from image plane, the out-plane imaging is spoiled due to beam divergence.

In ML-based nanoscope, the ML has been used to overcome the diffraction limit. The ML is operated in near field (above the specimen ˜300 nm) and collecting high order diffraction including part evanescent waves to generate super high resolution images. The present technology demonstrates that the evanescent field between specimen and ML was enhanced as they closed to each other, and 18% energy coupling efficiency was achieved with distance of ˜300 nm (FIG. 28D). As the evanescent waves were coupled into ML, there are two paths for them to involve into imaging: transforming into propagation wave or whisper gallery waves.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1A illustrates a conventional microscope, a plano-convex ML, and an XYZ piezoelectric stage;

FIG. 1B illustrates the conventional microscope, plano-convex ML, and XYZ piezoelectric stage of FIG. 1A;

FIG. 1C illustrates lenses on a glass slide attached to a z-stage, the z-stage, a CCD camera, and a second camera port of the present invention;

FIG. 2 illustrates a microlens printing using a micropipette;

FIG. 3 illustrates a second approach to microlens printing utilizing a self-assembly process;

FIGS. 4A-4E and FIGS. 5A-L illustrate the super high resolution imaging of different structures using delinquent salt-based microlenses using a halogen-tungsten lamp providing white light;

FIG. 6 illustrates a virtual image tracked through zeroth order light;

FIGS. 7A-7H illustrate various high-quality fluorescent imaging and scanning of nanoparticles;

FIGS. 8A-8D illustrate four frames of a scanning video of a species of diatoms observed with a nanoscope;

FIG. 9 illustrates a spiropyran copolymer used in the present invention;

FIG. 10 illustrates shifting of the position of the microlens;

FIG. 11 illustrates a schematic of a Salt Microlens for Ultra-high Resolution Imaging (SAMURI) system;

FIGS. 12A-12G illustrates various views of MLs formed at MC spots surrounded by an SP layer through self-assembly by selectively staying in the hydrophilic MC regions;

FIGS. 13A-13G illustrate a sequential printing method with pipettes;

FIG. 14 illustrates various images of low vacuum 10 keV EDS maps;

FIG. 15 illustrates various images of low vacuum 10 keV EDS maps;

FIGS. 16A-16F illustrate microscopic views of a microlens;

FIG. 17 illustrates various images of real imaging performed using CaCl₂ MLs;

FIGS. 18A and 18B illustrate images of a diatom species Aulacoseira lirata;

FIGS. 18C and 18D illustrate intensity distributions of a magnified region and along three pores, respectively of the diatom species of FIGS. 18A and 18B;

FIGS. 19A-19G illustrate various views of microscope images of various gaps and nanoscale holes of the MLs;

FIG. 20A illustrates the dispersion relations of some materials having different refractive indices, and FIGS. 20B-20F illustrate various images of a ZnCl₂ immersion;

FIG. 21 illustrates excitation light being focused by the microlens;

FIG. 22 illustrates a divergent beam model of the present invention;

FIG. 23 illustrates intensity distributions at the focal plane quantitatively revealing the weight of energy carriage of each spatial order;

FIGS. 24A-24D illustrate fluorescent intensity distributions of two groups of nanoparticles;

FIG. 25 illustrates various views of two separated groups of nanoparticles and intensity distribution analyses thereof;

FIGS. 26A-26F illustrate fluorescent nanoparticles and corresponding SEM images for positing and confirming;

FIGS. 27A-27D illustrate out-plane images with decent qualities, and FIGS. 27E-27H illustrate imaging quality decaying as an objective left off the image plane;

FIGS. 28A-28D illustrate the coupling efficiency of a microlens;

FIGS. 29A-29F illustrate the resolution of a microlens; and

FIGS. 30A-30E illustrate various ray tracing models.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

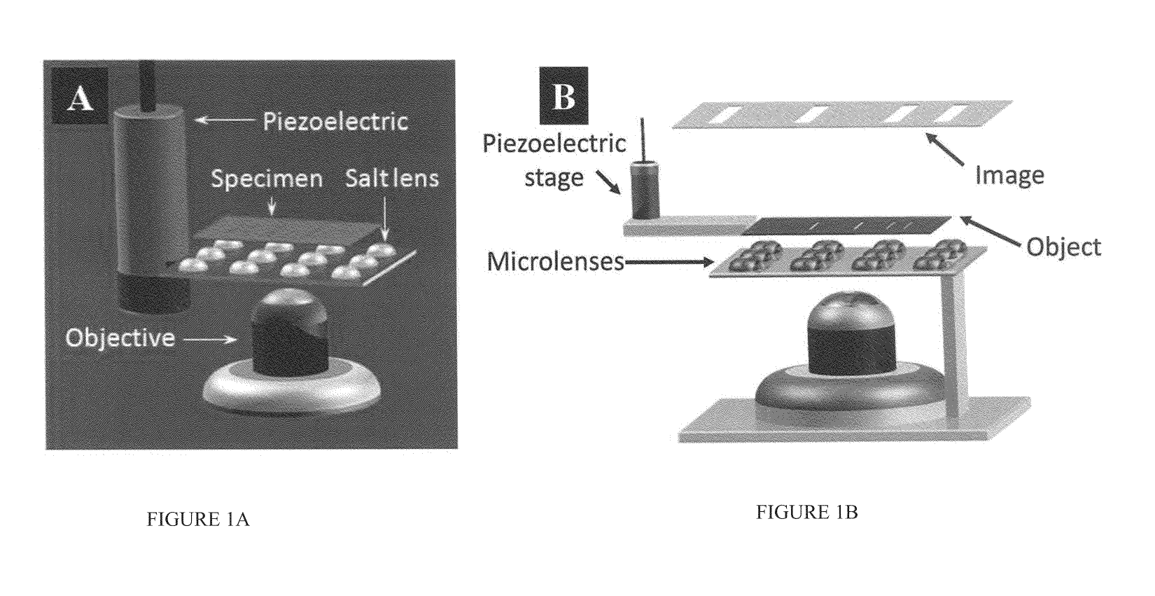

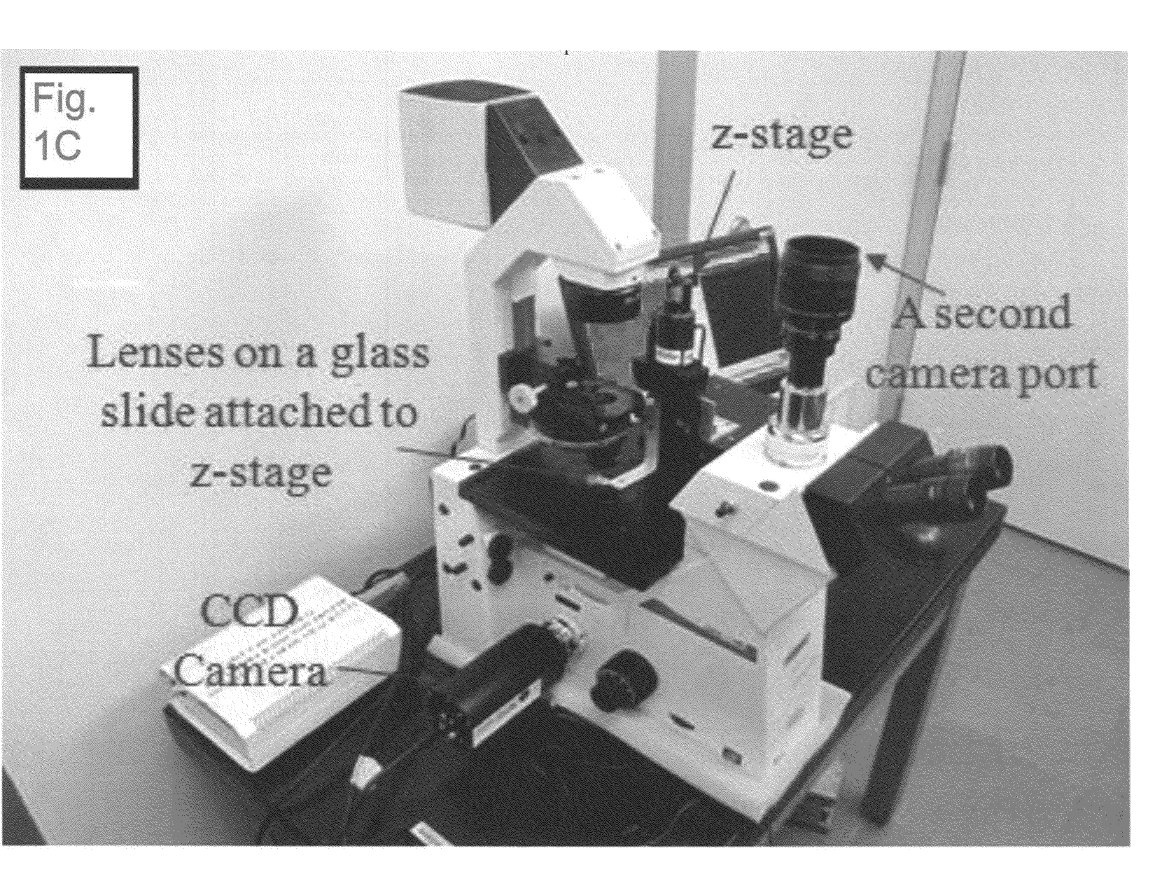

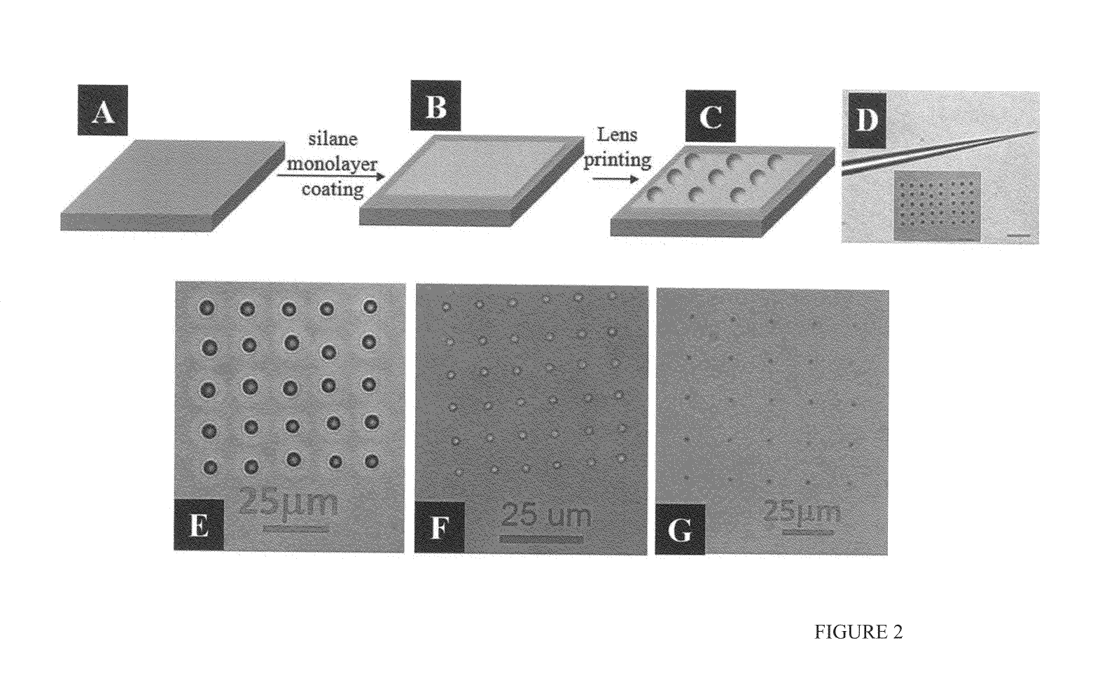

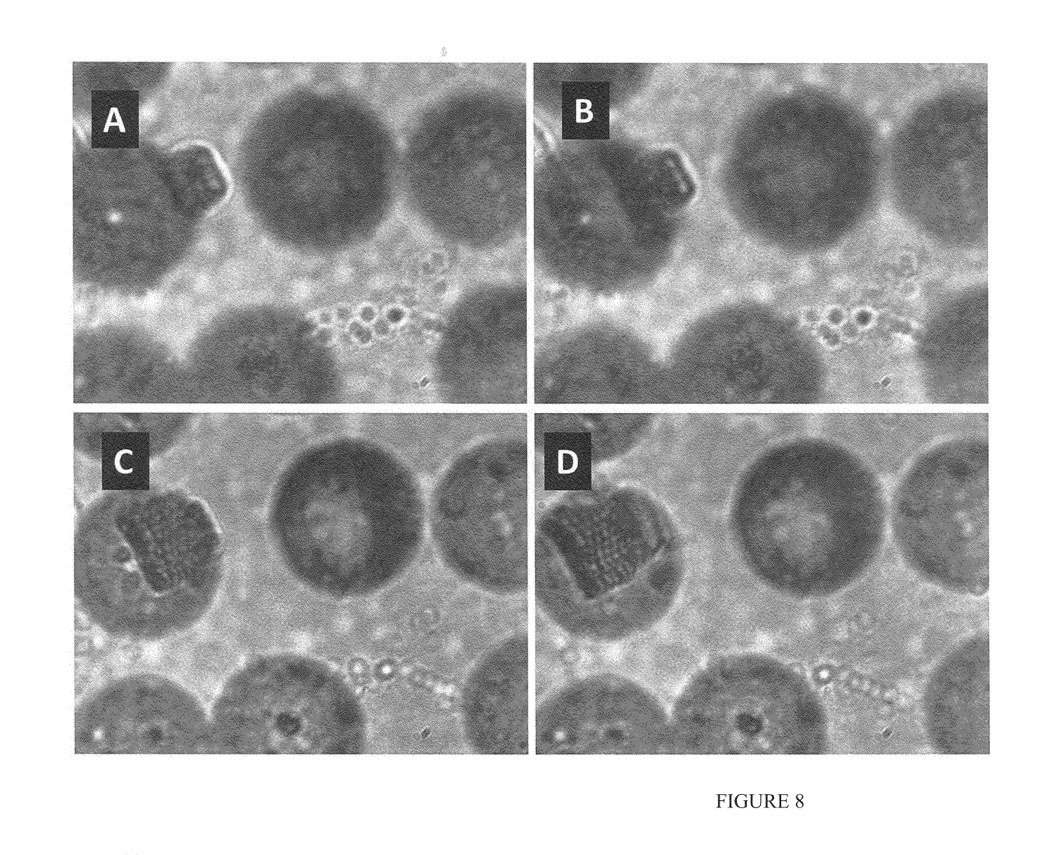

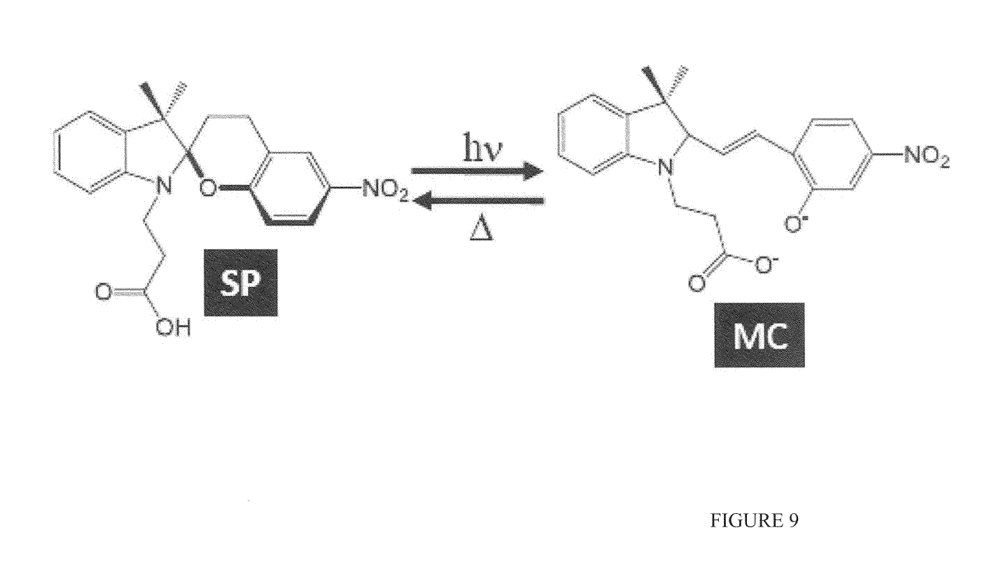

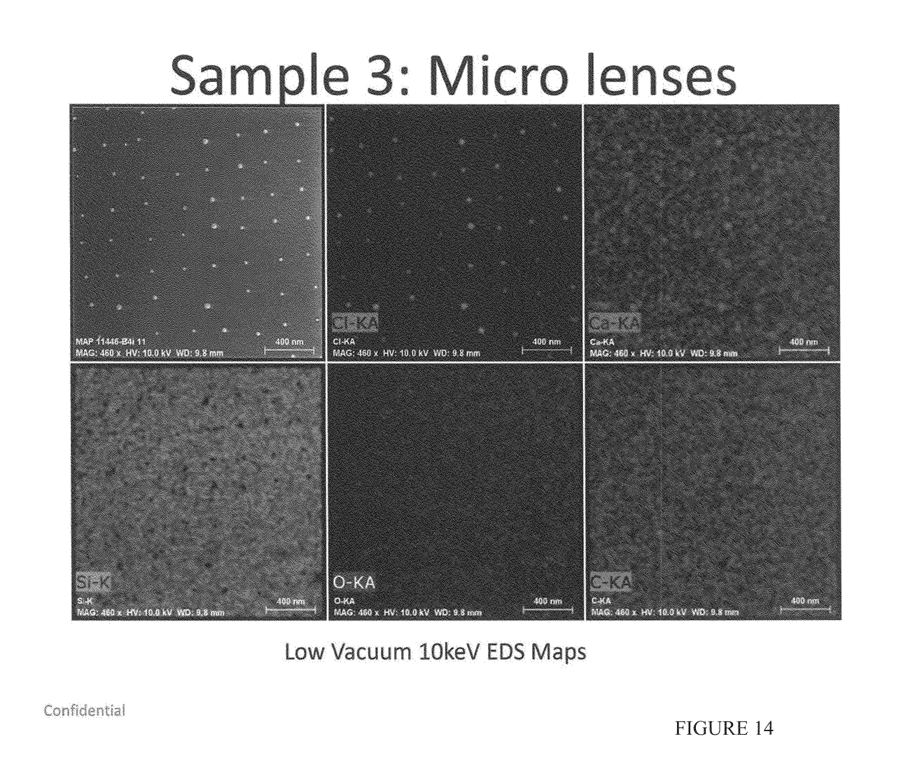

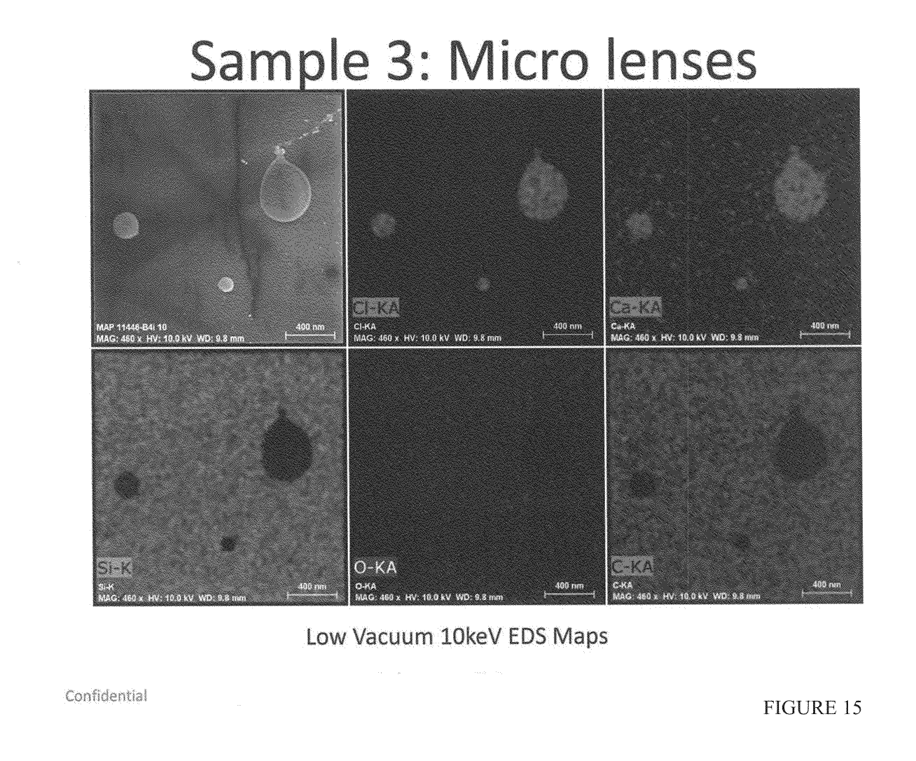

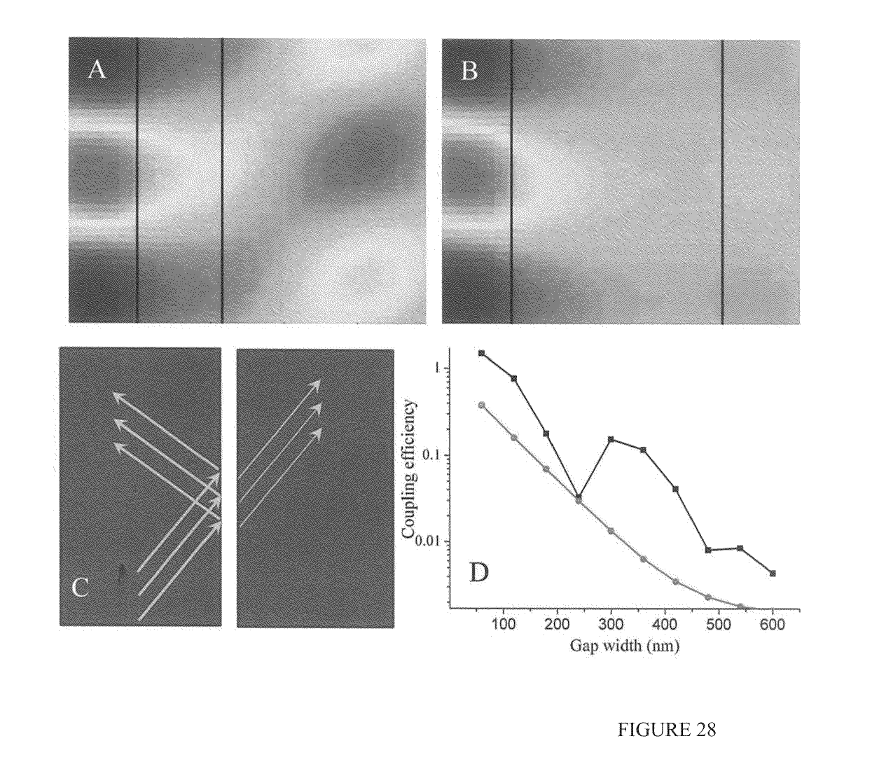

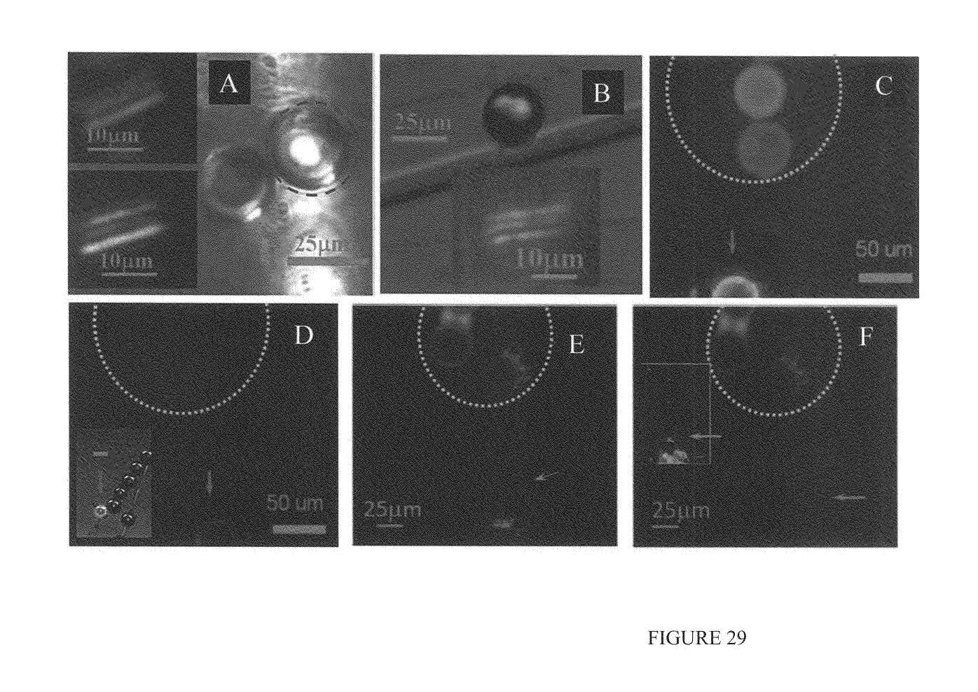

According to the embodiment(s) of the present invention, various views are illustrated in FIGS. 1-30 of the drawings.

The technology as disclosed and claimed herein is a plano-convex deliquescent salt microlens (ML) based optical microscopy and scanning technique which can achieve resolution <100 nm using white light illumination without any significant modification to the conventional microscope. In the case of the glass ML, the ML is spherical constructed of glass microspheres. ML is operated in a very near approximate to the objective. The diffractive light from objects, including propagation waves and parts of evanescent waves, is picked up by ML and transferred into propagation or whisper gallery waves, forming the primary enlarged and super-resolved virtual image. Then the primary image is observed with microscope for a secondary magnification.

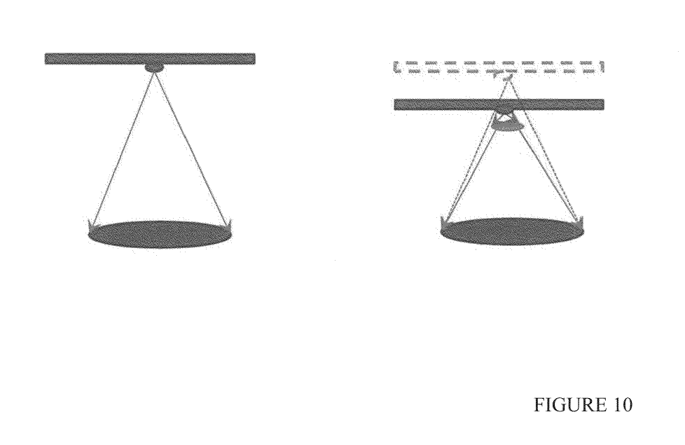

The ML-based nanoscope consists of a conventional microscope, a plano-convex ML, and a XYZ piezoelectric stage (FIGS. 1A and 1B). ML is inserted between the specimen and the objective. The specimen is mounted on the XYZ-stage and can be driven to accomplish the scanning. This Salt Microlens for Ultra-high Resolution Imaging (SAMURI) system utilized a white-lighting halogen-tungsten lamp with a dominant wavelength (λₘₐₓ) at ˜600 nm (FIG. 11, SOM). By driving the objects very close to the salt ML, both propagation and evanescent light diffracted from the objects are picked up by ML. The produced super-resolution and enlarged images are then magnified by the microscope and captured by eyes or a CCD camera or other sensor or receptor.

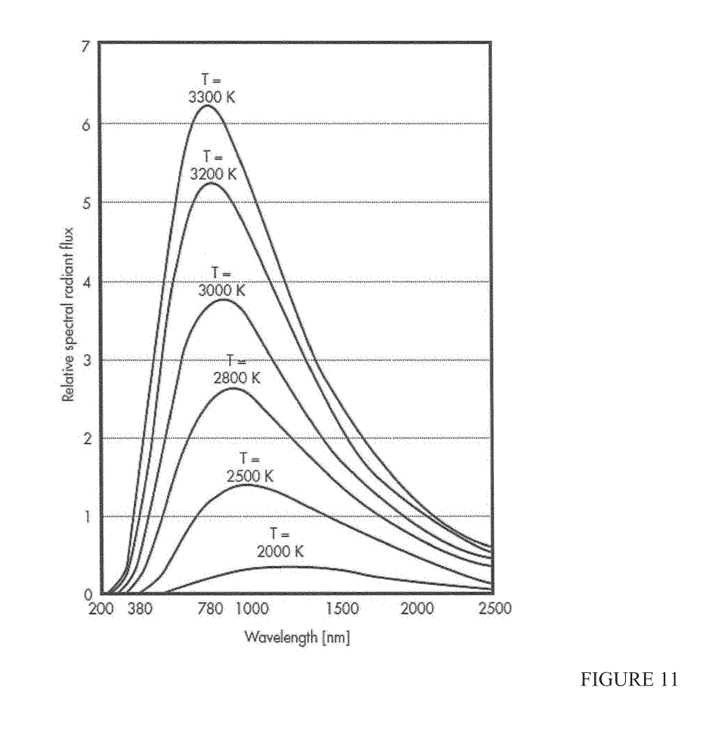

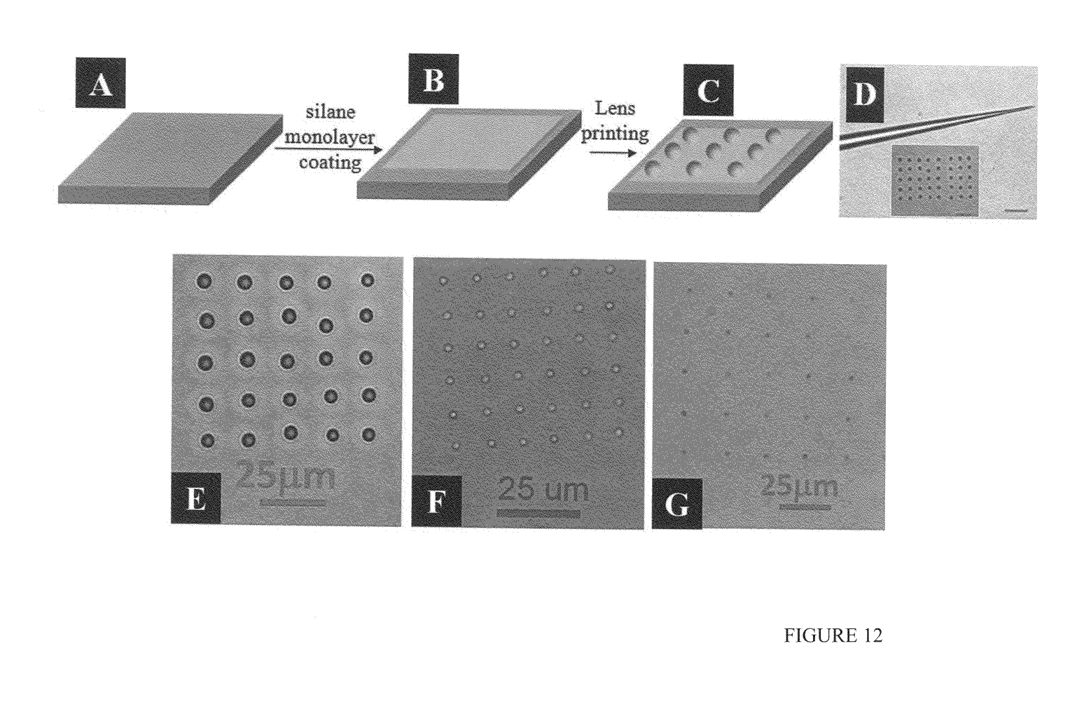

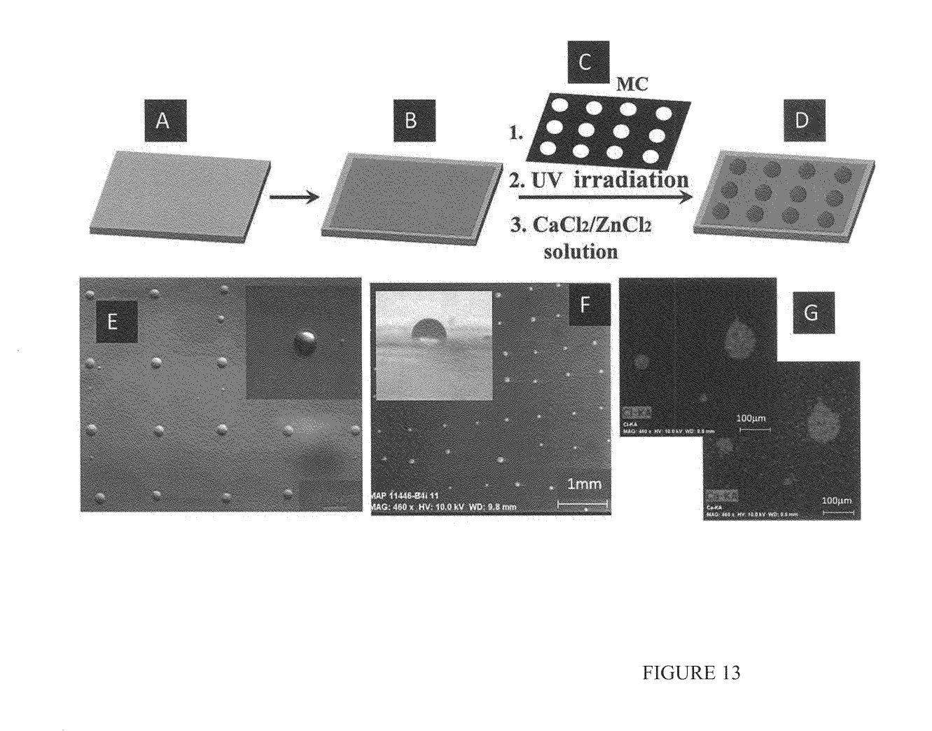

A new method for fabricating an array of ML by using delinquent salt solutions is disclosed and claimed herein. We self-assembled salt (a saturated solution of CaCl₂, ZnCl₂ or KHgI) droplets on a spiropyran (SP) surface that was photoactivated to merocyanine (MC) through a mask with hexagonally packed holes of 150 MLs were formed at MC spots surrounded by SP layer through self-assembly by selectively staying in the hydrophilic MC regions (FIG. 12). Through self-assembly process many billions of monodispersed MLs can be fabricated inexpensively (Movie 1, SOM). MLs were also fabricated using a sequential printing method with pipettes (FIG. 13). MC (dipole moment ˜60×10⁻³⁰ cm) possesses a significantly larger dipolar moment than SP (dipole moment ˜10×10⁻³⁰ cm), and is the basis of formation of ML by stabilizing MC through metal-MC complexation. By using different sized pipettes and adjusting the writing time and solution concentrations, the size of MLs can be controlled between 700 nm-30 μm. MLs have spherical optically smooth surfaces because of surface tension, and maintain liquid state at T˜10-40° C. and RH>15% owing to deliquescence nature of the salts (SOM, FIG. 14). The lenses are stable for more than 3 months when kept in a high relative humidity (RH) environment. The drying of the lenses was also observed when they were kept at a very low RH (<15%) but recovered after keeping them in an atmosphere with RH>20%.

One embodiment of the present invention comprising a salt microlens teaches an apparatus and method for nanoscopy. The details of the invention and various embodiments can be better understood by referring to the figures of the drawing. Referring to FIG. 1, the microlens-based nanoscope consists of a conventional microscope, a microlens, and a XYZ piezoelectric stage is shown (SEE FIGS. 1A-1B). The microlens is mounted on a xyz piezoelectric stage (FIG. 1A left), equivalently, we also can mount the specimen on the xyz piezoelectric stage (FIG. 1B). The specimen is placed above the microlens which is a plano-convex lens. FIGS. 1A and 1B show the set up employed for the Salt Microlens for Ultra-high Resolution Imaging (SAMURI) using halogen-tungsten lamp with a dominant wavelength at 600 nm. A magnified virtual image of the specimen is obtained when the distance between microlens and specimen is less than the focal length of the microlens. The virtual image can then be magnified by the microscope and captured by eyes or a CCD camera. For achieving high quality images, the microlens-specimen and microlens-objective distances can be carefully adjusted. The distances can be adjusted by the Z-stage and focus knob of the microscope.

In one embodiment of the microscope, a broadband white light illumination is adopted by using 100W quartz tungsten halogen lamps with a color temperature of 3300 K and 3600 Lumen. Tungsten halogen incandescent lamps have blackbody-like emission spectra, and the emission spectrum is clearly related to the tungsten temperature. With increase in the blackbody temperature, the emission peak from the lamp blue-shifts. At the highest practicable temperatures (˜3300 K), λₘₐₓ-850 nm. In this case, the fraction of visible, UV, and infrared radiation were ˜20%, 0.3%, and ˜79.7% respectively. The melting point of tungsten (3383° C.) does not allow λₘₐₓ in the visible. It is clear that the tungsten halogen lamp has larger weight long wavelength emission in visible light range. Assuming the peak emission is at 600 nm, the conclusions reached herein by further assuming λₘₐₓ˜600 nm do not change, and in fact with λₘₐₓ˜850 nm, resolution dₛ—531 nm for a microscopy with N.A.=0.8, the data and conclusion suggests that use of microlenses enhances the resolution by 2/7.

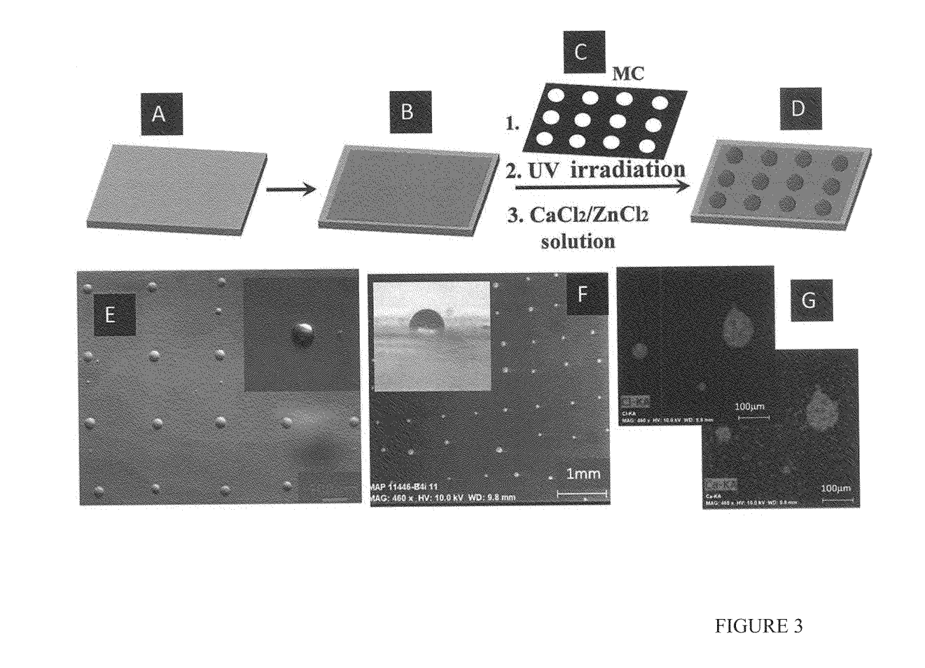

The microlenses can be fabricated by using two approaches: One method used as disclosed herein involves printing the microlenses using a micropipette (FIG. 2). We printed MLs by delivering aqueous salt solution through a micropipette on to a C18-silane functionalized hydrophobic glass surface force. The pipette is easily filled with salt solution due to capillary force and is used for printing lenses on functionalized glass. For example, the diameter of the pipettes can range from 150 nm to 10 μm. The size of the lens can thereby be controlled between 700 nm and 30 μm by choosing different pipette tip size, and by adjusting the writing time, and using different solution concentrations (FIG. 2E-2G). The droplets have hemi-spherical surface shape due to surface tension where the curvature of the droplets is dictated by the surface energy of the substrate. Because of the deliquescent nature of salts, the droplets maintain liquid state for a temperature (T) range 10° C.<T<40° C. and relative humidity (RH)>15%. The surface tension of the droplets maintains an optically smooth surface without any further processing.

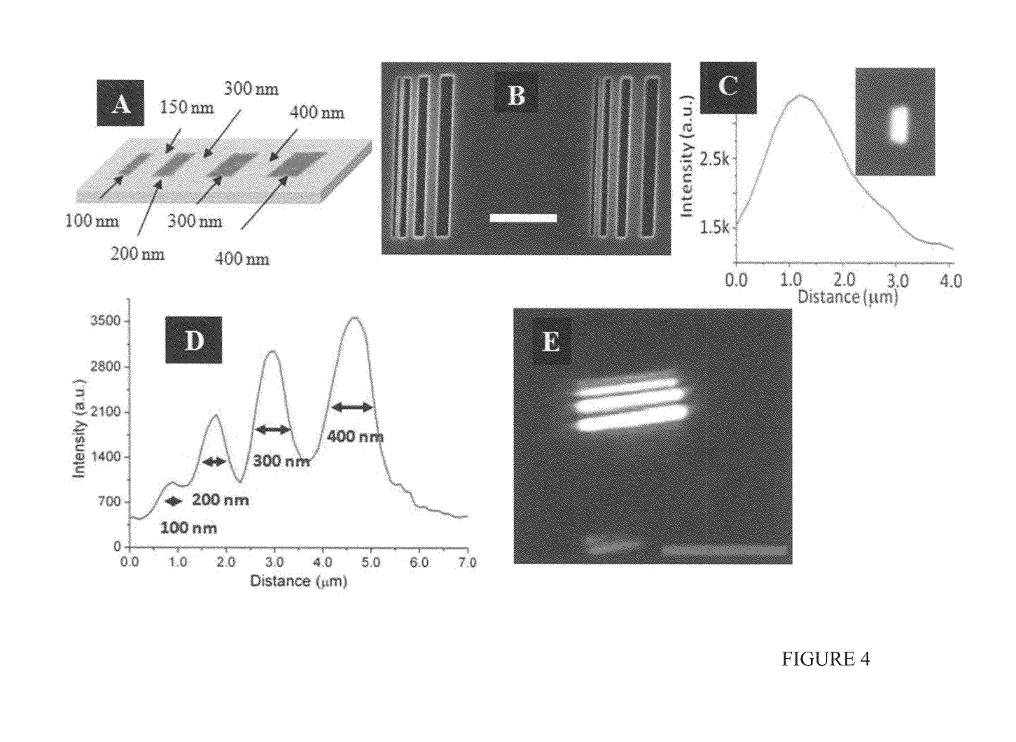

A second approach utilizes the self-assembly process and is shown in FIG. 3. We first synthesized hydrophilic hexagonal patterns (˜20 μm) surrounded by a hydrophobic surface. This is achieved by coating a glass substrate with a thin layer (thickness 500±100 nm) of spiropyran (SP) through a mask that has hexagonal packed holes of diameter, d=155 μm and periodicity, f=255 μ. The spiropyran copolymer that can be used is presented in scheme.

UV (254 nm) exposure of the film through a periodic circular patterns are transferred on to spiropyran film The deposited glass was then kept in a 30 mM calcium chloride ethanol solution for 2 minutes and stored in 50% RH at T˜298 K. Spiropyran is a well-known class of photochromic molecule that undergoes a reversible photocleavage of the Spiro C—O bond. UV exposure of the films allows switching between a ring-closed, colorless spiropyran (SP) form and a ring-opened, strongly colored merocyanine (MC) form. The change in nature of the bonds in SP after exposure to photons also implies that the surface tension of the spiropyran films is easily altered photochemically, namely, from a less polar/hydrophobic molecule (SP) to a more polar/hydrophilic form (MC). Therefore, we used differences in polarity for the selectively fabrication of MLs array at hydrophilic sites that were activated using UV radiation through a mask.

Because of differences in the surface tension of droplets on SP and MC, the evaporation rate for MC (hydrophobic) region is much faster than that for SP (hydrophilic) region. The droplets were stabilized by metal-MC bond formation on the film at the hydrophilic regions which were surrounded by hydrophobic regions. Due to high deliquescent nature of calcium chloride, these droplets maintain an aqueous state whose volumes keep equilibrium with the surrounding humidity.

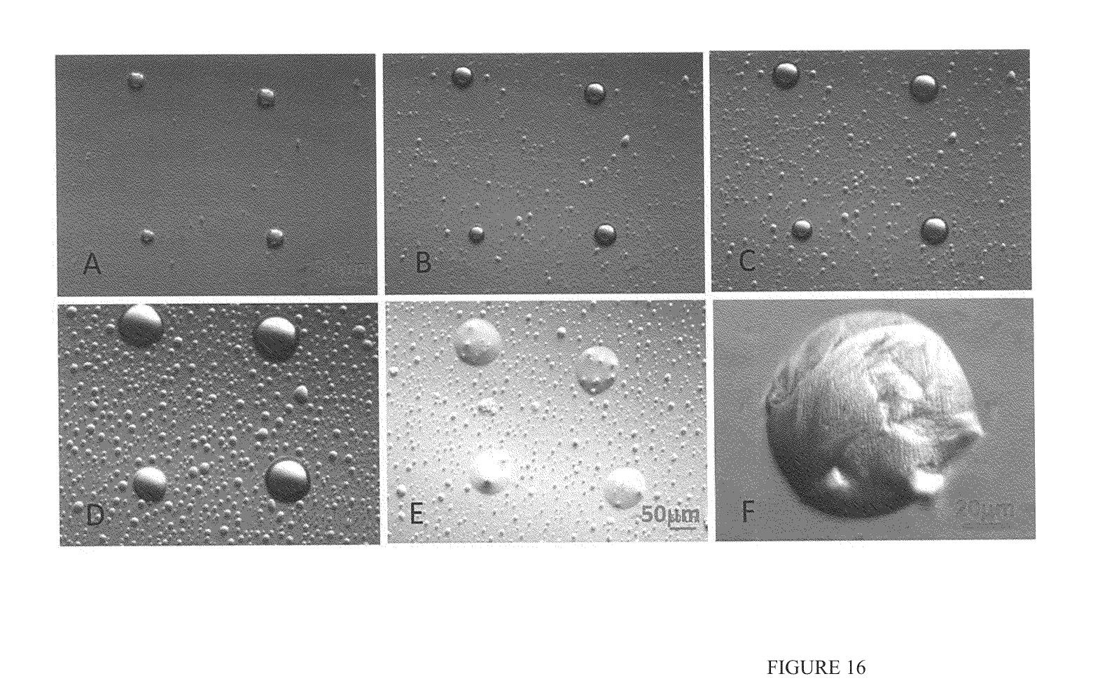

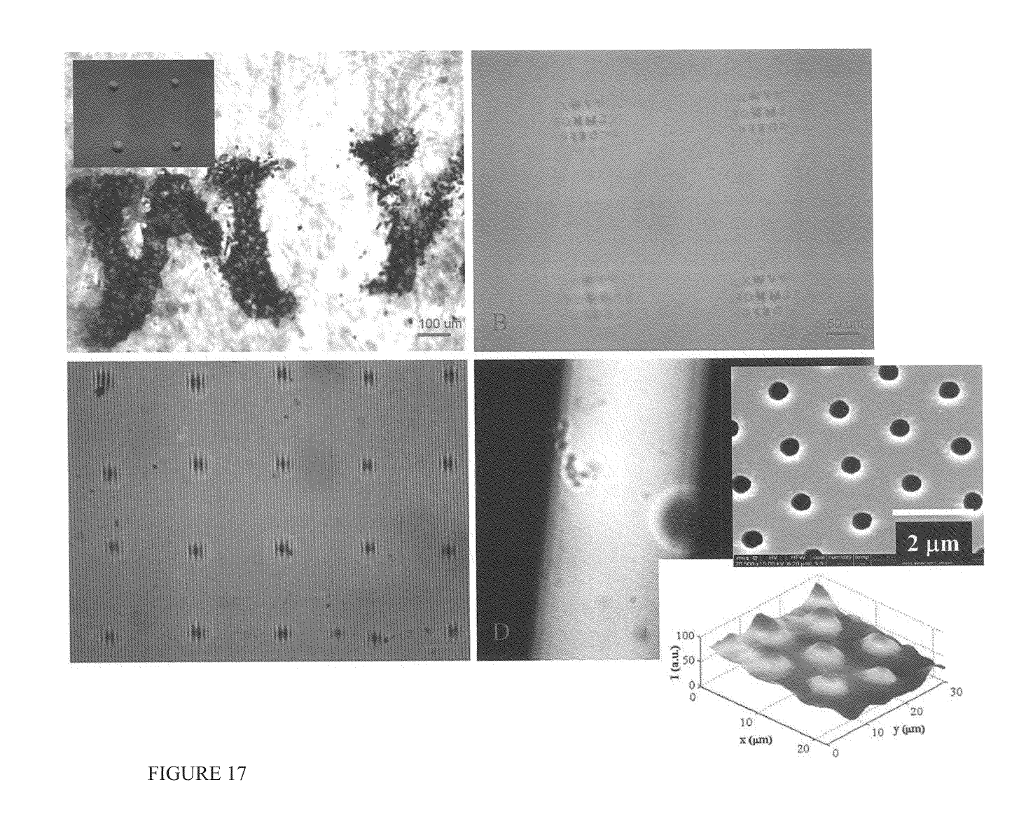

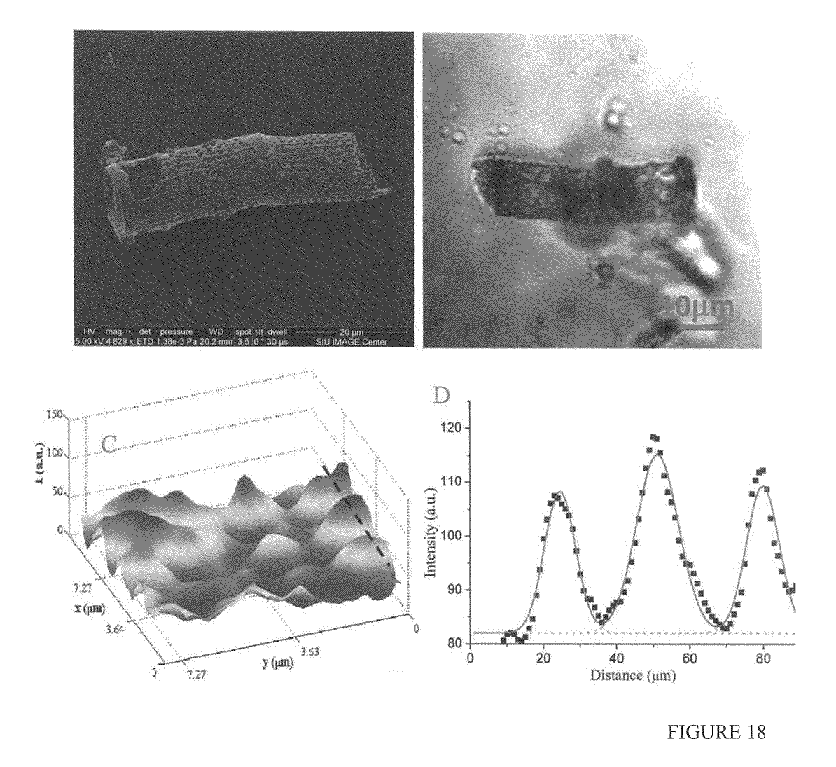

FIGS. 3E and 3F show optical and electron micrographs of an array of MLs fabricated by self-assembly process respectively. Insets in FIGS. 3E and 3F show higher magnification optical micrographs of top and side views of an ML respectively. Energy Dispersive X-ray (EDX) analysis of the MLs shows that lenses contain Ca and Cl elements only, and Si, C, and O elements were absent suggesting that MLs do not contain SP/MC. The EDX spectrum is devoid of Si even though the MLs are formed on glass or Si substrates. This is because EDX probes samples up to a few microns of depth whereas MLs in FIGS. 17-18 were 10-100 μm in diameter. Because the EDX data was taken at low pressure (10-20 Pa), the MLs composed of saturated salts were not fully dehydrated.

For microlens made up of deliquescent salt, because the high bond number of the solution, the deformation of gravity can be neglected and the surfaces of these droplets can be regarded as plano-convex surfaces. The contact angle between droplets and glass largely depends upon surface functionalization of glass. We investigated the thermodynamics of the droplets. At thermodynamic equilibrium, the chemical potentials of the vapor and liquid states of water outside and inside of a droplet are same.

μ_{H}_{₂}₀⁰+RTInp_{w}=μ*_{H}_{₂}_{O}+RTInα_{w} (1)

where μ_{H}_{₂}_{O}⁰ and μ*_{H}_{₂}_{O} are standard chemical potentials of the water vapor at 1 atm. and the aqueous water at the same temperature and pressure as the solution; and p_{w} is the water vapor pressure. α_{w}=γ_{w}m_{w} is the water activity in solution where m_{w} is the mole fraction of water in solution; γ_{w} is the activity coefficient which specifies properties of non-ideal solution; R is gas constant, and T is the equilibrium temperature. For pure water in equilibrium with its vapor, α_{w}=1 and p_{w}=p^{o}_{w} (saturated vapor pressure of water at T), therefore, μ*_{H}_{₂}_{O}−μ_{H}_{₂}_{O}⁰=RTInp_{w}⁰. Even if you do not have pure water in lens, it can be considered under equilibrium with its vapors. Therefore, the deliquescent relative humidity (DRH) is defined as,

$$\frac{DRH}{100} = {α}_{w} = \frac{{p}_{w}}{{p}_{w}^{0}} \qquad ( 2 )$$

Equation 2 implies that there is a critical relative humidity above which a medium becomes hygroscopic, and a new thermodynamic equilibrium will attained by absorbing sufficient water from air. It suggests that the size as well as the concentration of the solution can be controlled simply by changing the relative humidity; also the curvature of the lens can be tuned by the concentration of the solution.

The efflorescence of the micro-lens shows the crystalline structure of the lens. It is observed that the dimension of the microlens increases with the increasing of the humidity. Also, the contact angle conserved as the dimension of droplets increases. The evaporation with constant contact angle normally occurs on a hydrophobic surface.

The nanopore in a Si wafer was drilled using the following process. First, double-side-polished, boron-doped Si (100) was oxidized to an initial oxide thickness of √400 nm. A thin coating of a positive photoresist (PR) S 1813 (Shipley Microposit J2 PR, Marlborough, Mass., USA) was applied on one side of the wafer and a few square windows were opened following development. The other side of the Si wafer was also coated with PR and was coated on the other side and oxide was removed from the square windows by a reaction with buffered hydrofluoric acid wet etching. The wafer was then washed with de-ionized (DI) water. The PR was removed in acetone. The free-standing membranes were fabricating through an anisotropic etching using 20% TMAH in DI water at 90° C. (Mallinckrodt Baker, Inc Phllipsburg, NJ, USA). 30×30 μm² square windows were achieved in SiO₂ through self-limiting etching. The reactive ion etching (RIE) was used to reduce thickness of the SiO₂ membranes to 300 nm. Tetraflouromethane at 100 W with a gas flow rate of 15 sccm was used for RIE. Focused ion beam (Carl Zeiss, Peabody, Mass., USA) was used to mill holes in the free-standing oxide membranes.

A two-step photolithography process was used to achieve the structures on a thermally oxidized silicon wafer. In the first step of photolithography, a 3 mm wide line pattern was defined, and e-beam evaporation of 50 Å of titanium (as an adhesion layer) followed by 150 Å of gold was done. Lift-off created the metal lines on the wafer. The second optical lithography was done to pattern probing pads aligned to the metal lines. The probing pads were made of 100 Å titanium and 500 Å gold. A manual FIB milling process was performed on metal lines to make a scratch on the surface of the metal. A 30 kV acceleration voltage was used for the FIB scratching using Gallium ions. Different milling currents (100 pA, 20 pA, and 1 pA) and FIB scratching times (120 s and 60 s) were used to achieve optimum conditions.

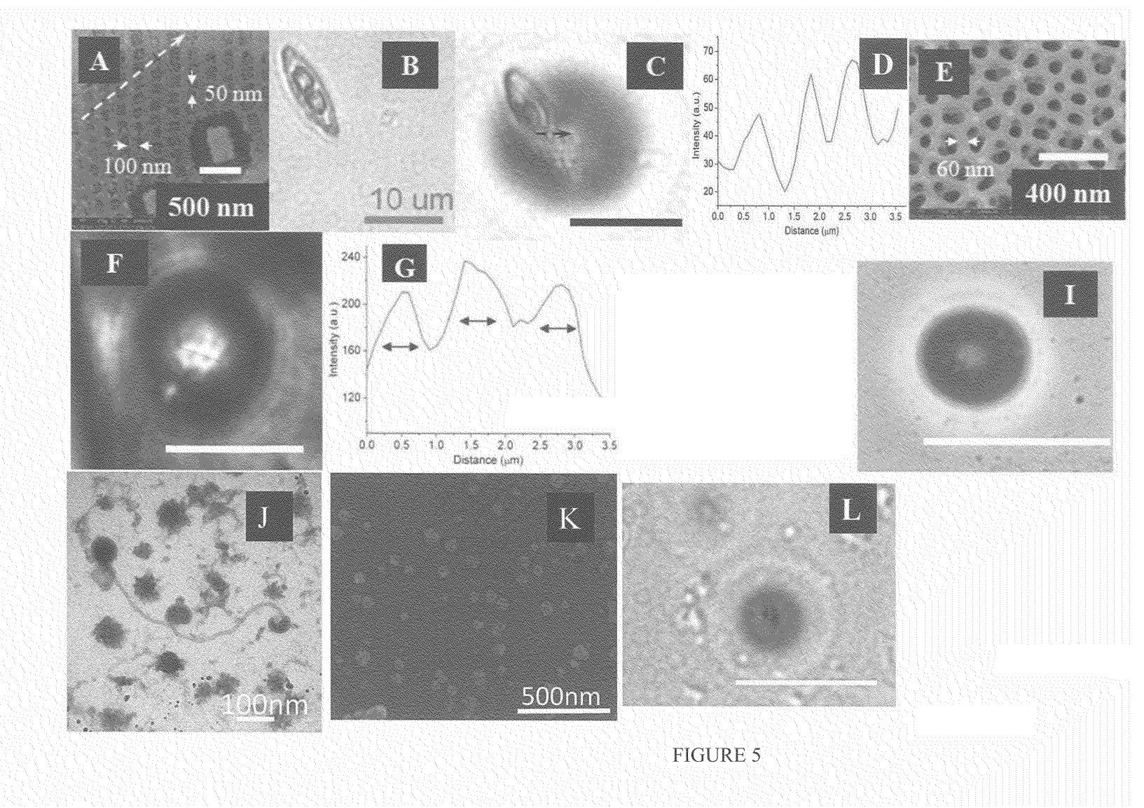

FIGS. 4 and 5 show the super high resolution imaging of different structures using delinquent salt-based microlenses using halogen-tungsten lamp providing white light (peak maximum wavelength, λmax, is ˜600 nm) Under these experimental conditions, ds in the far-field mode is ˜500 nm (NA:0.6 and λmax:600 nm). An optical photograph of the inverted microscope with Z-stage and microlens attached to it is shown. FIG. 4A shows schematic of a series of lines (blue structures) milled using a focused-ion beam (FIB) instrument on a 100 nm thick chromium-coated quartz substrate (grey in color, FIG. 4A). SEM of the corresponding structure is shown in FIG. 4B. The separations (S_{i,j}) between windows i and j were: S_{1,2}=(185+30)nm, S_{2,3}=(307+24)nm, and S_{3,4} =(414+28)nm. These windows were imaged under a conventional microscope (FIG. 1C) with a white light with and without HgKI-based microlens (diameter ˜8.6 μm). The features on the chromium coated quartz could not be resolved using the microscope without microlenses (FIG. 4C) but were readily resolved when the microlens was present the light path (FIG. 4E). Thus, the design disclosed herein overcomes white-light diffraction limit and achieved a ds ˜λ/3.33 in the far-field mode along with a magnification of ˜2.2.

To further test the resolution power of microlenses, the nanoscope design was used to image Synedra diatoms, anodic aluminum oxide, bacteriophage S1 and bilayer vesicles (FIG. 5). FIG. 5A shows an SEM of a Synedra diatom which has nanostructures of ˜100 nm and silica walls of 100 nm and 50 nm thick surrounding it. These structures were not resolved in the microscope (FIG. 5B) but were resolved when a ZnCl₂ microlens was kept at ˜300 nm distance over it (FIG. 5C). FIG. 5D shows line scan of the resolved nanostructures along the arrows in FIG. 5A and 5C. Also synthesized were anodic alumina with pore diameter of in 80-130 nm range and pore wall thickness of ˜60 nm (FIG. 5E). The nanopores are easily resolved with a white light illumination using HgKI microlens of diameter 10 μm (FIGS. 5F and 5G). Interestingly, in this case the device can resolve structures with ds˜60 nm and a magnification of ˜5.5. The resolution for a HgKI microlens was found to be larger than those of ZnCl₂ and CaCl₂ based microlenses. This is because HgKI lenses have a larger n˜1.73 than those of ZnCl₂ and CaCl₂, The nanoscope design was then used to observe bilayer polydiacetylene vesicles (˜50-300 nm in size, FIG. 5H) using ZnCl₂ microlenses (FIG. 51). Finally, the nanoscope was use for ZnCl₂ microlens to observe bacteriophage S1. A TEM image of the phage S1 is presented in FIG. 5J, and the size of the phage is ˜70 nm. In a SEM image (FIG. 5K), on the leads of S1 are observed. Discerned is the phage S1 using the microlens but cannot observe them outside of the microlens region (FIG. 5L). These high resolution images clearly confirm that the delinquent-salt based microlenses can easily break the physical diffraction limit using a white illumination in a far-field optical microscope. Therefore, through the use of proposed microlenses, super-high spatial resolution was achieved without any significant changes in the microscope or need of additional hardware or software.

When real imaging is performed by using CaCl₂ MLs (inset in FIG. 17A). It is observed that a reduced alphabets imaged by each ML, and the letters are in the upside down orientation from that of objects which is displayed in FIG. 17A. The object and the image distance are S=1500 mm and S′=166 μm respectively. The image was observed to shrink by >9 times from the original object (FIG. 17B). We derived an average focus length f=146 μm for MLs. This value is consistent with calculated values based on lens maker's equation of f=140 μm for L=55 μm.

Although there is only a very small region that can be magnified due to the finite aperture size of microlens, the image of the whole object can be acquired by scanning the lens throughout the object. The scanned image can be further process with a computing system. In FIG. 17C, a micrograph of the scanning image through the lens array is displayed, where the microlens array is mounted on a 3D adjustable stages (with adjust accuracy of 0.5 μm in x and y and 0.15 μm in z). For getting a higher resolution, a small microlens with diameter of 20 μm is applied to observe a membrane which consists of hexagonal lattice of holes with diameter D=450 nm and lattice constant a=900 nm. The virtual image is shown in FIG. 17D. The objective of the microscope we use is Leica 20×, N.A. 0.45, corresponding to a resolution of 750 nm.

The intensity distribution from the membrane is plotted in the inset in FIG. 17D. Based on the intensity distribution, it is clear that the membrane consists of hexagonal lattice of holes. The diameter of the holes and the lattice constant are 2.0 μm and 4.5 μm, respectively suggesting magnification, M˜5. This set up also demonstrated that use of MLs resolution much higher than the far-field diffraction limit of the objective used in these experiments.

For example, a CaCl₂ microlens can observe a species of diatoms named Aulacoseira lirata. The diatom has a cylindrical body and oral shaped pores are spread throughout the body. The pores size is 300 nm-800 nm, and the distance between pores are ˜600 nm-1500 nm (FIG. 18A). The diatom image is achieved 1.92 times magnification by using an ML with a diameter of 24 μm (FIG. 18B). The intensity distributions of the magnified region are presented in FIG. 18C, and an intensity profile along three pores is plotted in FIG. 18D. It is shown that the long axes of pores are from 0.9 μm to 1.6 μm, and the distance between each two pores is about 2.4 μm.

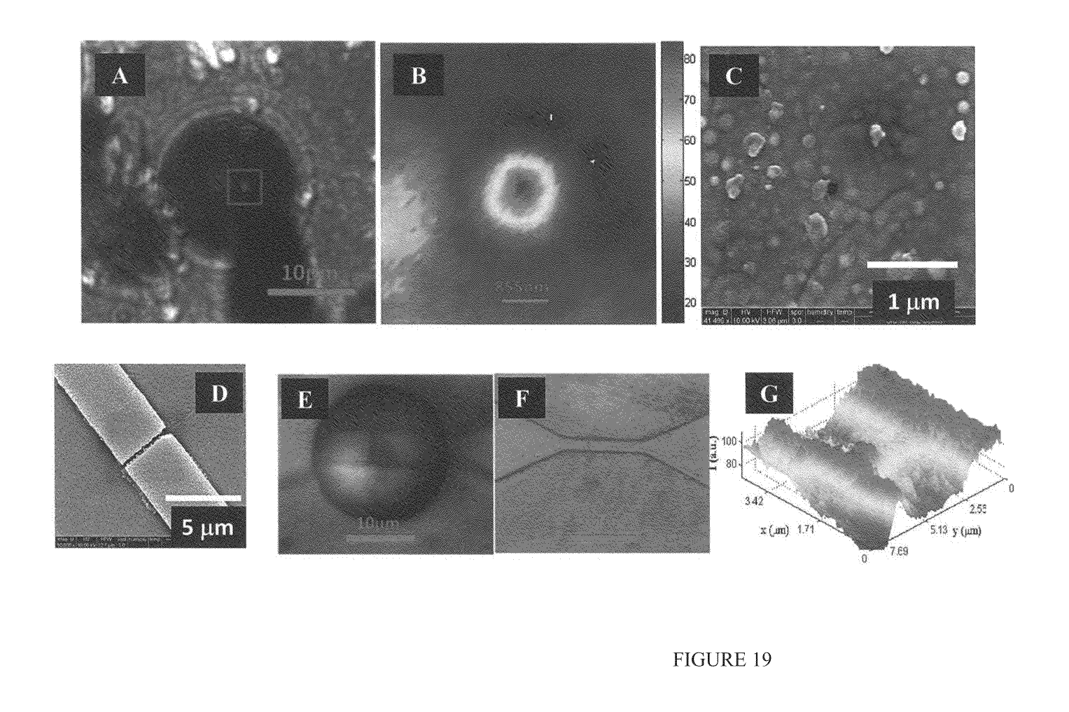

Further testing the capability of MLs, using ZnCl₂ aqueous MLs (D=22 μm) (n=1.58). An inverted microscope with an objective of 100× and NA=0.8 is used to observe a hole with length and width of ˜151nm and 108 nm respectively (FIG. 19C). The nanoscale hole is drilled in a thin silicon oxide membrane sitting on a silicon substrate with FIB. The nanoscale hole does not appear a perfect circle but has a long axis of 1.0 μm and short axis of ˜900 nm (FIG. 19B). Therefore, the hole is magnified ˜6.25 times by using an ML.

Also observe is a microscale electrode with a break-junction, and the gap between two electrodes is ˜200nm (FIG. 19D). FIGS. 19E and 19F show a break junction gap between two gold electrodes with an ML (D=19.5 μm and η=1.57) and without an ML respectively. The magnification of the image was increased by 2.1 times, and the image is easy discerned with the use of ML (FIG. 19G).

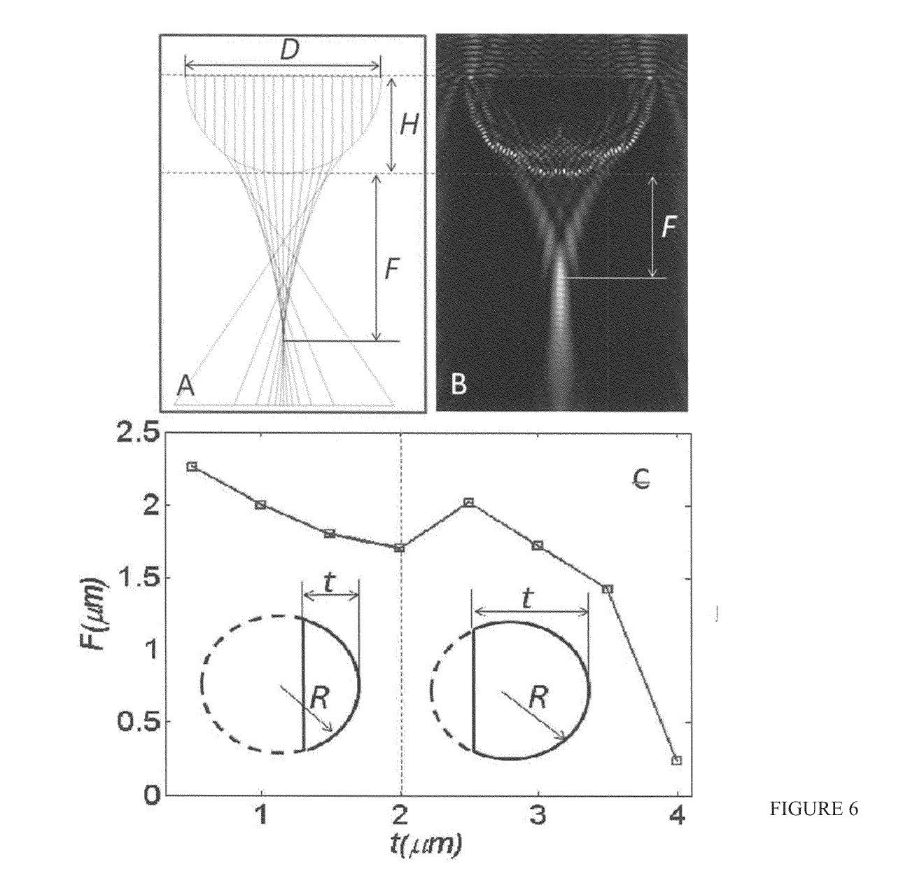

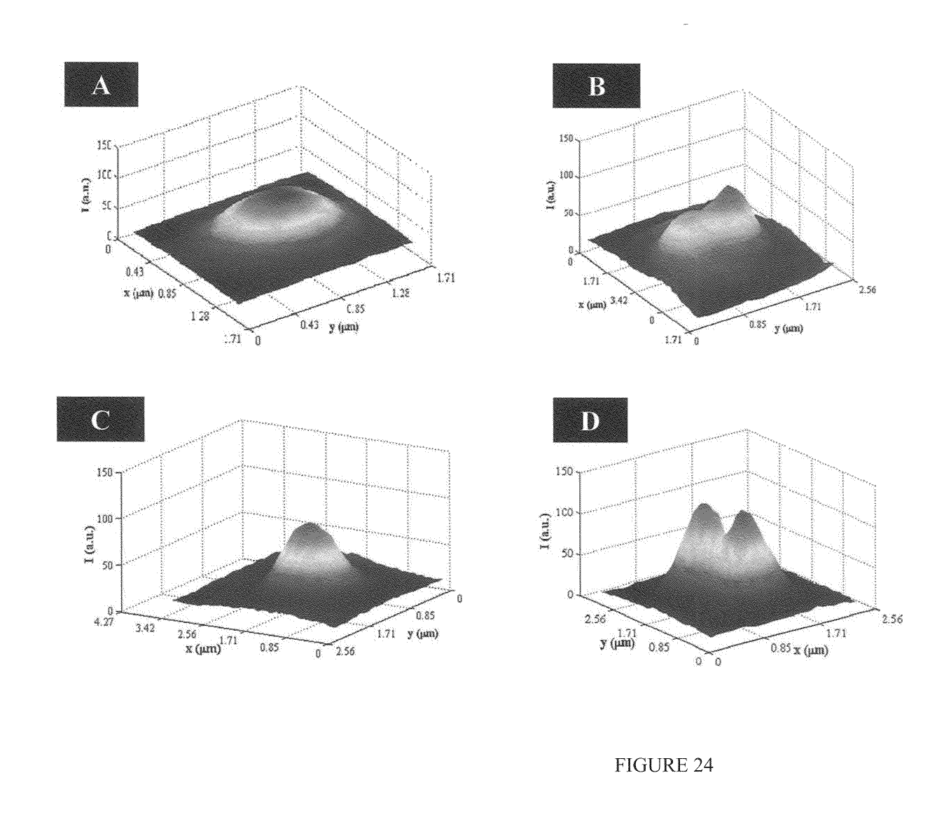

Our MLs also provided high-quality fluorescent imaging and scanning of nanoparticles. A 13 μm diameter ZnCl₂ ML is used to observe Nile-red impregnated fluorescent nanoparticles (diameter˜90-400 μm)immobilized on a glass slide. FIGS. 7A and 7E shows the SEM images of two groups of nanoparticles in which the specific two particles /particle blocks separated each other with a distance of 85 nm and 240 nm, respectively. These nanoparticles are not distinguishable without ML (FIGS. 7B and 7F) but clearly resolved with ML (FIGS. 7C and 7G). It is consistent with the 3-D intensity profiles (FIGS. 24 A-D), in which only one peak is observed without ML but two with ML. The use of ML greatly enhanced the emission, e.g. the peak intensity enhances 1.3 and 1.4 times and the integral energy improves 3.6 and 3.4 times for the two groups of nanoparticles, respectively. The intensity profile cross the two centers of nanoparticles is shown in FIGS. 7D and 7H. The two peaks were fit well with Gaussian.

The magnification: M=Dₒ/Dₑ, where Dₒ and Dₑ are the optical distance between two peaks in the Gaussian fit and the distance measured using electron microscopy, respectively. So we achieved 1.54 and 1.37 times magnifications using ML. We defined the size is measured as the width of 60% modulation. For the first group, we get the spacing between the two is 187 nm, suggesting a real size of 120 nm, which is very close to 92 nm measured in SEM image. The diameters derived from optical micrographs are 0.53 μm and 0.56 μm (corresponding to 0.34 μm and 0.36 μm in real); for the second group, the spacing distance is 0.31 μm measured with microscope, corresponding to a real size of 0.22 μm, close to the data got from SEM (240 nm, respectively). It is demonstrated that ML not only significantly enhanced the image resolution but also greatly improve the emission rates of fluorophores. So ML based microscope fits well with the fluorescence imaging.

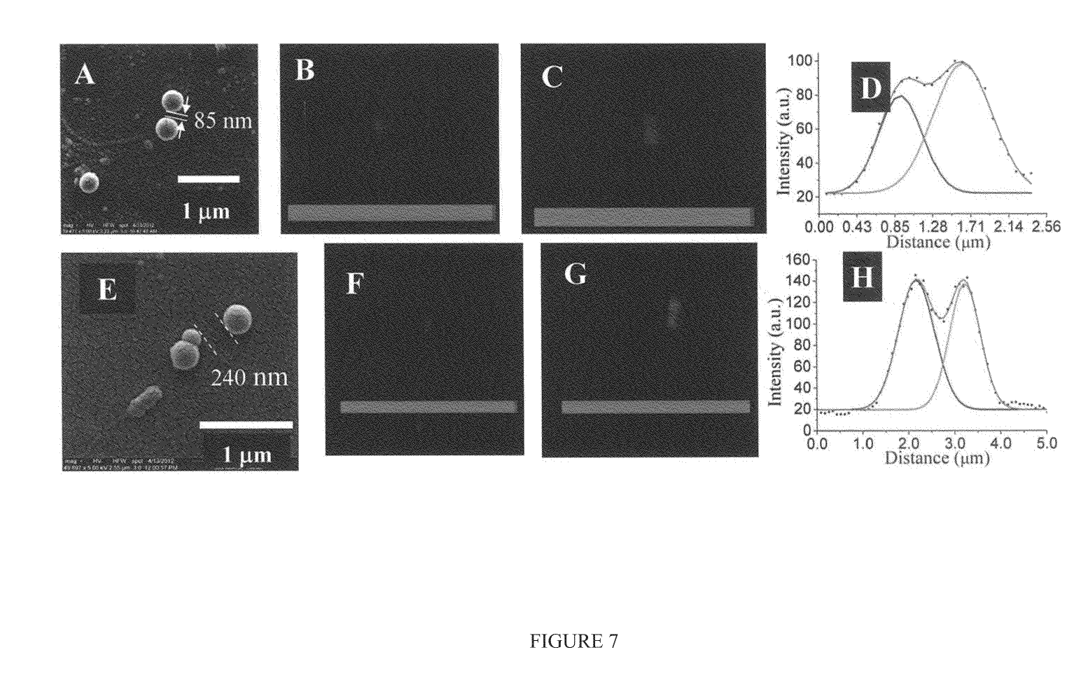

The microlenses are also easily using for scanning. Since there is a small gap between specimens and the ML, the scanning can be accomplished by moving the specimens or ML using a XY piezoelectric stage. This is very useful for large size samples. Due to small size of the microlenses, the throughput rate for capturing the images would be limited. This is especially true for specimens that are large and may require longer scanning time. To enhance the throughput of the near field images, the microlens array can be used for simultaneously capturing the multiple images. Instead of scanning the whole specimen using a single lens, each lens in the array needs to scan only a small region, and the whole image can be obtained by merging all the images taken by each microlens. To accomplish reproducible and high quality imaging with multiple microlenses, the microlens-specimen distance and lens parameters (refractive index, dimension, and contact angle) for all the lenses in the array should be same. In FIGS. 8A-8D, we showed 4 frames of the scanning video of a species of diatoms named Aulacoseira lirata observed with nanoscope. The diatom has a cylindrical body and oral shaped pores are spread throughout the body. The pores size is 300 nm-800 nm, and the distance between pores are ˜600 nm-1500 nm. It is demonstrated that the features of the diatom has been clearly sighted with using the nanoscope.

In ML-based nanoscope, the ML has been used to overcome the diffraction limit. The ML is operated in near field (above the specimen ˜300 nm) and collecting high order diffraction including part evanescent waves to generate super high resolution images. We demonstrated that the evanescent field between specimen and ML was enhanced as they closed to each other, and 18% energy coupling efficiency was achieved with distance of ˜300 nm. As the evanescent waves were coupled into ML, there are two paths for them to involve into imaging: transforming into propagation wave or whisper gallery waves.

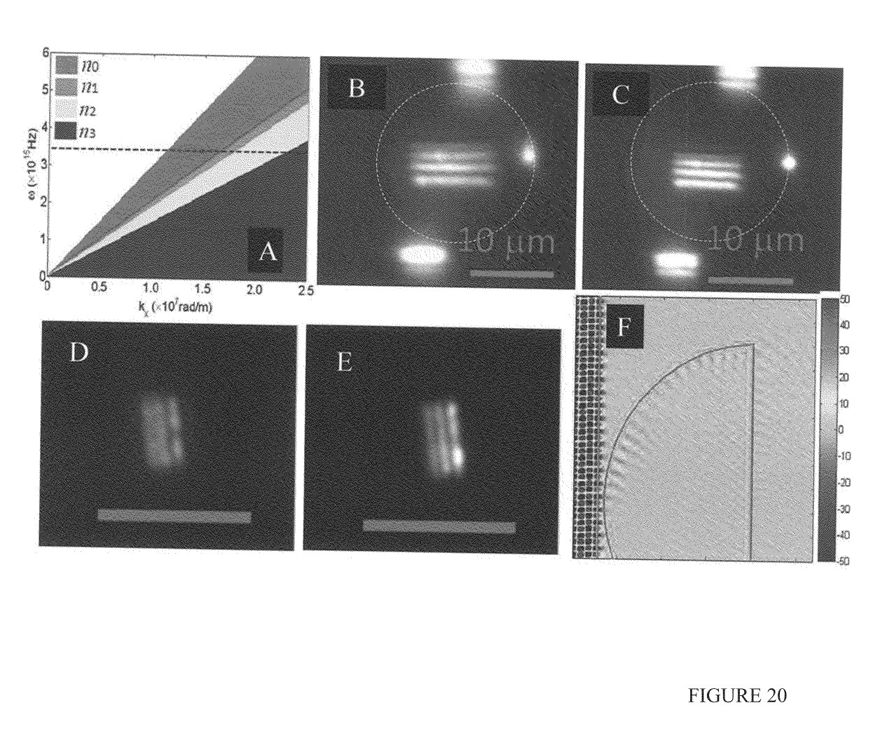

In FIG. 20A, we show the dispersion relations of some materials with different refractive index, where n₀=1, n₁=1.46, n₂=1.57 and n₃=1.73 are air, water solution of CaCl₂, ZnCl₂ and HgKI, respectively. The line of each material forms a light cone (we draw half only). Propagation waves are all inside of the light cone but evanescent waves are located in colored regions. Obviously, the higher refractive index material supports more spatial waves than the lower one. It was verified in FIGS. 20B and 20C, where the image of ZnCl₂ ML is much sharper than that of CaCl₂ ML. This effect also can be verified in FIGS. 20D and 20E, where the images of etched windows were observed without MLs but filled with air and ZnCl₂ saturated solution. It is noticed that the ZnCl₂ immersion (n=1.57) gave higher resolution than air, but the windows were not totally resolved, even not as good as CaCl₂ ML, suggesting an important enhancement of resolution comes from the spherical shape of ML.

We believe that a much higher resolution achieved by using MLs also contains a contribution from excitation of whisper gallery waves (E2W) supported at the surface of MLs. For simulation of the evanescent waves of object coupling to whisper gallery modes sustained by hemi spheres, we choose a dielectric slab with refractive index n=1.9 and a TE-polarized plane wave in the slab is incident to the slab surface with an incident angle θ=80°, so that evanescent waves are excited at the slab-air interface. A glass hemi-spherical microlens (n=1.51, r=6 mm) placed on a glass slide (n=1.51) is put close to the slab with a distance of L=60 nm. For the setting, the excited evanescent waves are decayed both in air and in glass.

However, since the spherical surface of ML sustains WGMs, the evanescent waves are coupled to WGMs, becoming propagation waves. The WGMs are then scattered at the ML-glass slide interface, and scattering waves are collected by objective and involved into imaging. For comparison, we attached the glass slide on the slab, and because the glass slide does not support the excited evanescent wave, there is no light propagates inside of the glass slide.

It was also demonstrated that the resolution decrease due to surface defects of MLs. A cylindrical defect with diameter of 1.5λ and depth of λ is design on the surface of a ML (n=1.51, r=6 mm). The WGMs are scattered by the defect, which greatly decreases the intensity guided by the ML surface. Therefore, the loss of higher order waves leads to the decrease of the imaging resolution.

Coupling out of the WGMs is another way to decrease the imaging resolution of MLs. For verification, we designed a MLs relay and coupled evanescent waves from one end of relay. It is seen that the WGMs are guided by the relay, which explains the fluorescence experiments of ML relay in this paper. In addition, since the WGMs can be coupled out by another ML, it is demonstrated that the two attached MLs come to a reduced resolution image.

The resolution can be attributed primarily to two factors: one is the numerical aperture enhancement of microscope, and the other most important is the evanescent waves coupling of the microlenses. For the formal one, the use of microscope projects the specimen into a virtual space behind the specimen. To observe these primary virtual images, the objective should be moved much closer towards the specimen than non-microlens case. Hence, higher angular scattering light can be collected by the objective, corresponding to the enhancement of the numerical aperture.

In addition, the inserting of the substrate of microlenses (usually glass slide and n₁=1.51) also shortens the objective-specimen (O—S) distance, leading to an increase of numerical aperture. The new N.A. can be estimated by NA=NA₀/(1−Δx/x₀) where NA₀ is the numerical aperture of microscope prior to insertion of the glass slide; x₀ is the O—S distance without insertion; and Δx is the change in the O—S distance after insertion of the glass slide. The resolution enhancement by this factor is only increased about 0.05-0.1 of NA. What are values of x₀ and Δx in your case. The most important enhancement in the resolution comes from the collection of evanescent waves by the MLs as described below.

The microlens works above the specimen within a distance of 300 nm. In such a small distance, most propagation waves from the specimen are collected by the microlens. Furthermore, a part of slow-decay evanescent waves are also collected. The involvement of the evanescent waves into imaging resulted into super resolution of the nanoscope. The evanescent waves on the two surfaces of specimen and microlens are not passively exchanged but actively interact with each other, resulting to a strong combined mode on the two surfaces. The interaction of the two surfaces can be explained by a coupled two-oscillator model.

The enhanced resolution of microlenses, can be explained by considering a 2-D scattering problem. Assuming a TM-polarized light Hₛ(x,z) propagates along z-direction and is scattered by an object. The scattering magnetic field Hₛ(x,z) can be expressed by the integral of spatial harmonic waves: [1]

$${H}_{s} ( x , z ) = {\int }_{{k}_{x} \leq {k}_{0}} {α}_{{k}_{x}} {H}_{i} ( x , z ) {e}^{i ( {k}_{x} x + {k}_{z} z )} + {\int }_{{k}_{x} > {k}_{0}} {α}_{{k}_{x}} {H}_{i} ( x , z ) {e}^{i ( {k}_{x} x + {k}_{z} z )} \qquad ( 5 )$$

where αₖₓ is the scattering coefficient of the spatial harmonic of kₓ,

k₀=√kₓ²+k_{z}²=2π/λ is wave vector, n is refractive index and λ is wavelength. The scattering light has been written into two parts in equation 5: the first and the second parts correspond to the contributions of propagation and evanescent waves, respectively. In the far-field, since the evanescent part decays very fast (k_{z} is complex), only the first part can reach. Therefore, the resolution is determined by the highest spatial harmonic of kₓ collected by lenses, i.e. R=a/kₓ, where a is a constant varied by different resolution definition. According to Abbe's definition and kₓ≦k₀, the highest resolution in far field is specified by Rₕ=λ/2.

By using microlens (with diameter of submicron-20 micron), because the lens' size and/or focal length are close to the wavelength (they are not close to one another), the contribution of evanescent waves cannot be neglected. The evanescent waves enhance the resolution because much higher order spatial information involved. The resolution is still defined by R=a/kₓ, but it is k dependent due to the fast decay nature of evanescent waves. Since k_{z} is imaginary and can be expressed by k_{z}=i/Δz. The resolution can be rewritten

$$R = a Δ z ( 1 - \frac{1}{2} {( {k}_{0} Δ z )}^{2} ) \qquad ( 2 )$$

Equation 2 shows that the resolution increases with decreasing Δz, and Rₕ→λ/2 if D_{z}→1. The above is a much simplified model to interpret the enhanced resolution by evanescent waves, because it neglects the influence of microlens imposes on the object.

The acquired images are magnified at two different times through the nanoscope. The first magnification is attained by an ML: the light from a specimen is acquired by a microlens in near field (<300 nm) and constructed to a virtual image; the virtual image is super resolved because unresolved subwavelength features of the specimen are magnified to the range which can be recognized by the microscope. The secondary magnification is based on microscope: the primary image through microlens is magnified again by a microscope and reconstructed a secondary image which can be detected by human eyes or a camera.

For the primary magnification, if the size of microlens is much larger than the applied wavelength and the thickness of lens is negligible comparing to the focal length, the optical propagation through the lens can be well described by geometrical optics, and the optical imaging behaviors can be tracked by ray-tracing method. It is accurate enough to estimate the focal length with paraxial approximation which is described by f=R/(n−1), where R is the radius of curvature and n is the index of refraction. However, as the size of the lens decreases to the wavelength, the interference between the diffractive waves from the flat surface (incoming aperture) and the refractive waves from the convex surface becomes important. The superposition of the diffractive and refractive waves changes the interference condition estimated by paraxial approximation (refractive waves counted only), and it is invalid to analyze the light transmission using geometrical optics.

FIG. 12 shows a ray tracing simulation result of a ZnCl₂ microlens (n=1.57 and r=5 μm). The ray tracing gives a paraxial focal length f=8.77 μm. However, the rigorous EM calculation shows the focal length is shortened, and f=5.16 μm (FIG. 12). It is also verified that the focal point lies at the Fresnel diffraction region where the bright and dark spots alternatively occur along the optical axis (FIG. 12). So the constructive or destructive interferences between the diffractive and refractive waves could elongate or shorten the focal length. To further investigate the impact of diffraction, the focal point is put into different Fresnel diffraction region by changing the thickness of lens H. It is shown that, as H increasing, the focal length has a general decreasing trend. Observed is a little bump (elongated focal length) occurs under the decreasing background. The change of focal length implies the constructive or destructive interference between the diffractive and refractive waves (FIG. 12). There is another mechanism to guaranty the decreasing trend of the focal length with thickness of lens increase, i.e., large angle incidence. It is known that light is more refracted by a larger angle incidence for a spherical lens. For a thick lens, high spatial waves (large angle) are excited by the diffraction, and these waves guaranty the decrease trend of focal length.

Because of the large curvature of the convex MLs, large angle incidence on the lens occurs (FIG. 12). This contributes to a decrease in the focal length of MLs. Therefore, the two mechanisms result in the reduction of the focal length. Since the magnification can be expressed by M=f/(f−a), and a is lens-specimen distance, the shortening of the focal length implies the increasing of the magnification.

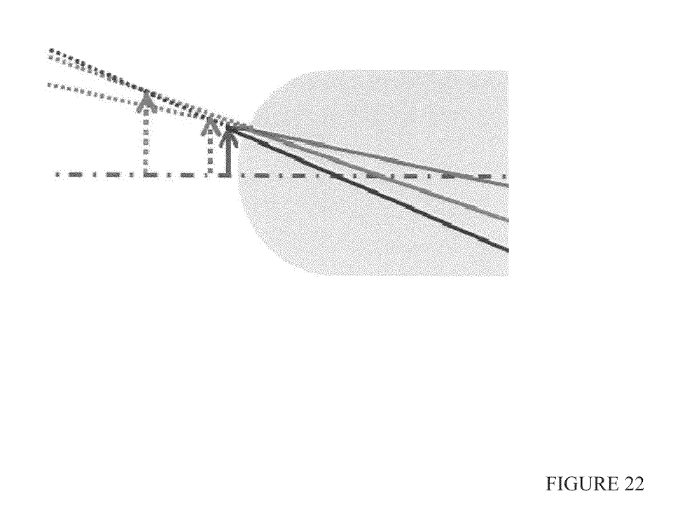

ML provides another mechanism to magnify the objects: Although there is an imaging plane which gives the most resolved image, imaging at a plane slightly from the focal plane can also provide good quality images. These out-plane images lost a little resolution but got an extra magnification. The magnification mechanism can be easily understood by a divergent beam model, FIG. 22. These out-plane images are not constructed by Interaction of the electromagnetic waves in real space, they are not subject to diffraction broadening. Therefore, these out-plane images are free of diffraction limit, and their resolution is only subject to the divergence of virtual light. The magnification of out-plane image can be estimated by (f+x)/f, where x is the distance of image to microlens. Although the out-plane images are not as sharp as the images in plane, they are still super-resolved.

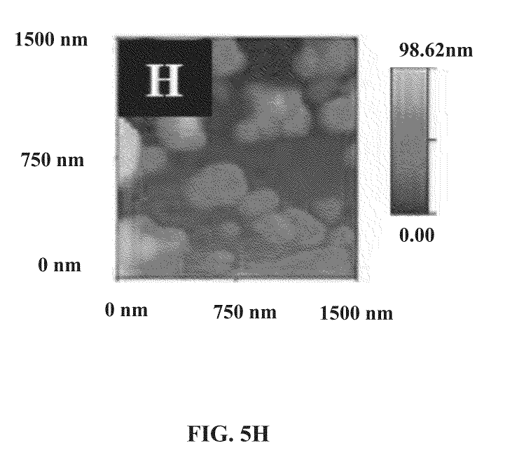

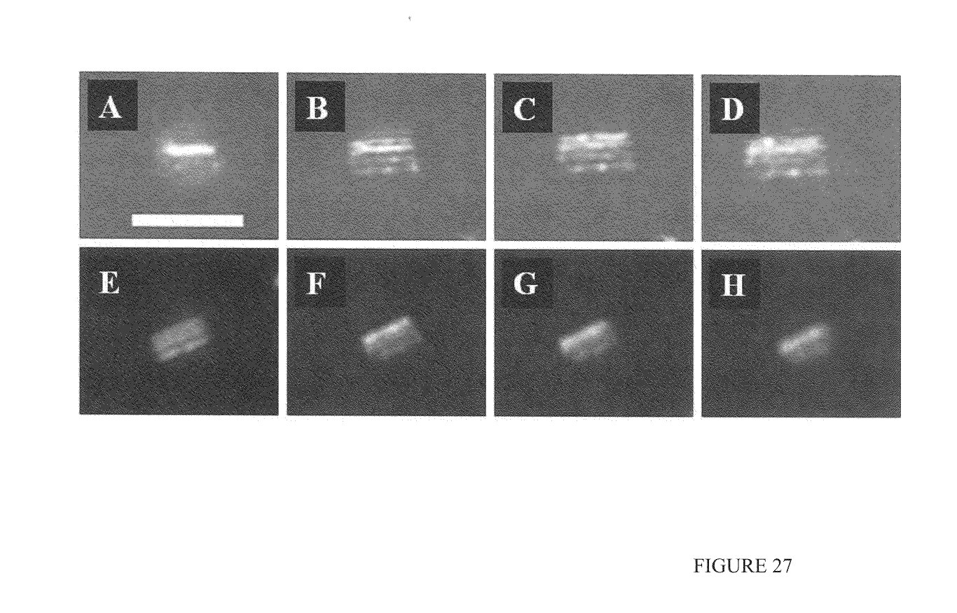

Another factor is that the divergence due to different spatial frequency is greatly suppressed by the microlens: the high refractive index of microlens reduced the divergence by a factor of 1/n; the spherical surface of microlens also decreases the divergence by a maximum angle of Δθ=cos⁻¹[R/(R+L)], L is the distance between the specimen to the microlens; the shortening of focal length suppresses the divergence. Therefore, the divergence of the light has been greatly suppressed by these effects, and the out-plane images keep sharp until divergence exceeds the angular width of the super resolved feature size. Another factor is the energy carried by different spatial frequency component of light, the calculation shows that the zeroth order of spatial order carries 75% total energy; it implies that the virtual images can be tracked through the zeroth order light, and the contribution of higher orders is to sharpen the virtual images (FIG. 6). Microscope is fit to observe the out-plane images since the microscope has tunable focus and short distance of focusing, where the former gives way to explore different out-plane images and the latter excludes the influence of objects and other images. With the use of ML, the image will be fast decayed with the defocus (FIGS. 27 E-H).

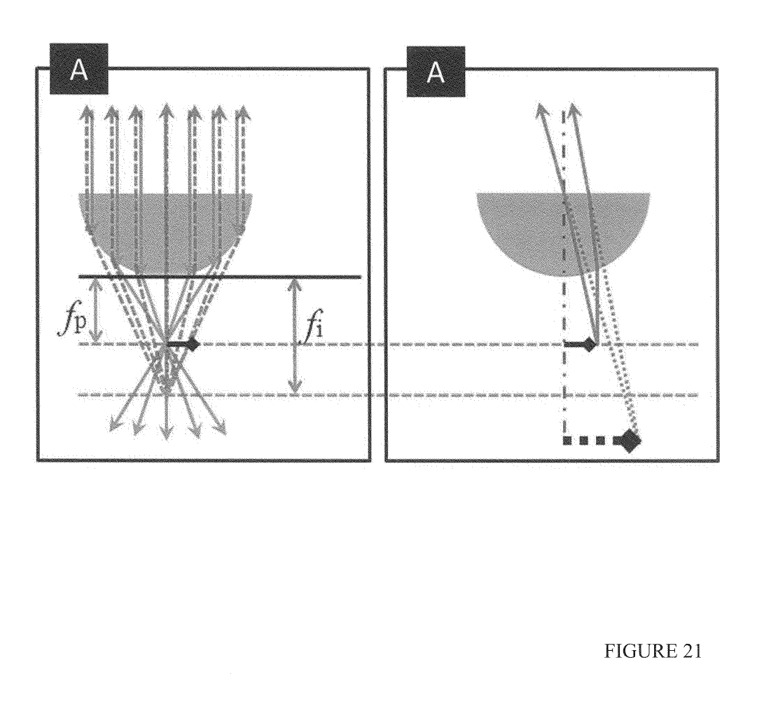

The enhancement of fluorescence can be attributed to at least two factors: a much excitation light focused on the object by microlens and the high emission collection ability due to the ultrahigh numerical aperture of the microlens. Since an inverted fluorescent microscope is used, the excitation light impinges on the sample by passing through the objective. When the microlens is applied, the excitation light will be focused by the microlens (FIG. 21). The intense excitation leads to a much stronger emission. The emission intensity Iₑ can be represented as a function of excitation Iₚ, which is expressed by,

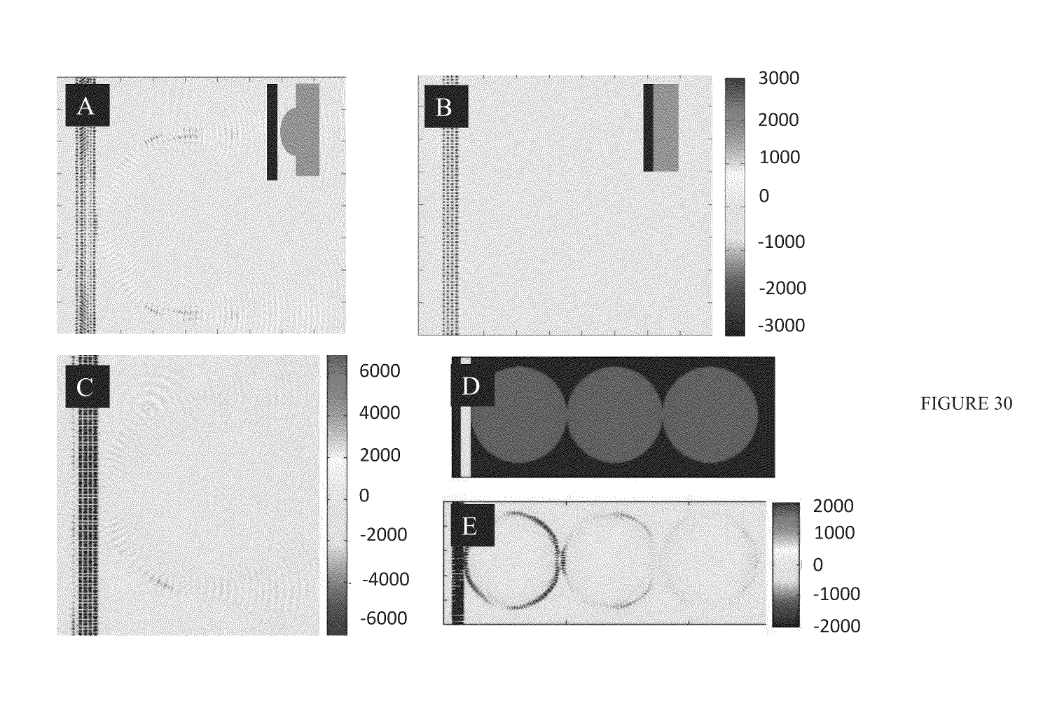

Iₑ=Iₑ₀(1−e^{-aI}^{ₚ}) (3)

Where Iₑ₀ is the saturated fluorescent intensity and a is a coupling coefficient which represents the effective rate of excitation. For a weak excitation, equation 3 can be approximated by Iₑ=Iₑ₀αIₚ, so the emission is proportional to the excitation. Therefore, the condensed excitation results in a stronger emission. By assuming the total light energy at the incident and transmission planes of a microlens are the same (neglect the reflection) and the intensity distributions are uniform, the ratio of excitation at the two planes is I_{pT}/I_{pI}=(D_{I}/D_{T})², where D_{I} and D_{T} are beam diameters at incident and transmission plane. Since I_{pI} is also regarded as the incident intensity without microlens, the enhanced ratio of emission by using (Iₑₘ) and not using microlens (Iₑₙ) can be roughly expressed by η=Iₑₘ/Iₑₙ=I_{PT}/I_{pI}=(D_{I}/D_{T})². Based on the ray tracing model (FIG. 30A), the ratio is estimated and η=4.2, where D_{I} is the diameter of incident pupil and D_{T} is the diameter of light at the output plane directly tangential to the microlens (In experiment, they have distance of 300 nm).

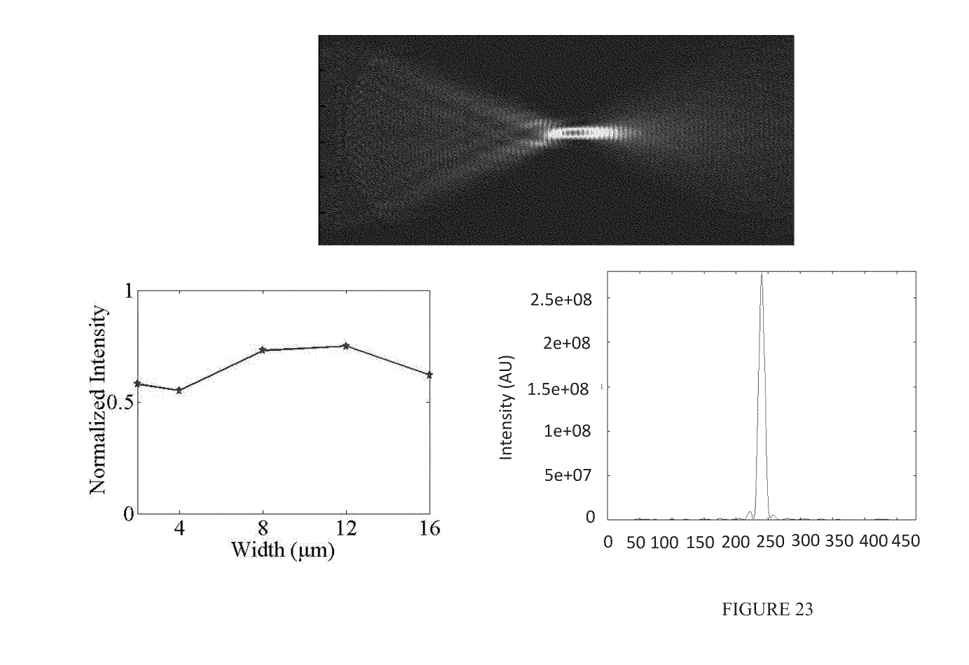

Considering the reflection loss and the nonuniform excitation, the enhancement in the emission is reasonable. The rigorous FDTD simulation also gives a emission enhancement ratio of 3.9, demonstrating it matches well with the simpler ray tracing arguments. Then we consider the contribution of ultrahigh numerical aperture of the microlens. It is well known that the images achieved using convex lenses are formed by the interferences of the direct passed light (the 0^{th} order) and the diffracted light. Most energy is carried by the low diffraction orders but high diffraction orders carry information of small features. The intensity distributions at the focal plane quantitatively reveal the weight of energy carriage of each spatial order (FIG. 23A). Obviously, more than 50% energy is carried by the 0^{th} order, and 95% energy is contained in the angular range of ±53° (corresponding to a numerical aperture of 0.8). Therefore, the high numerical aperture can enhance the imaging intensity but not a major factor. It is also validated from our experimental data, where the ratio of the integral intensities (η_{ε}=AIₑₘ/AIₑₙ, A is the emission area of specimen) are around η_{ε}=3.6, close to the estimated data form excitation (3.9).

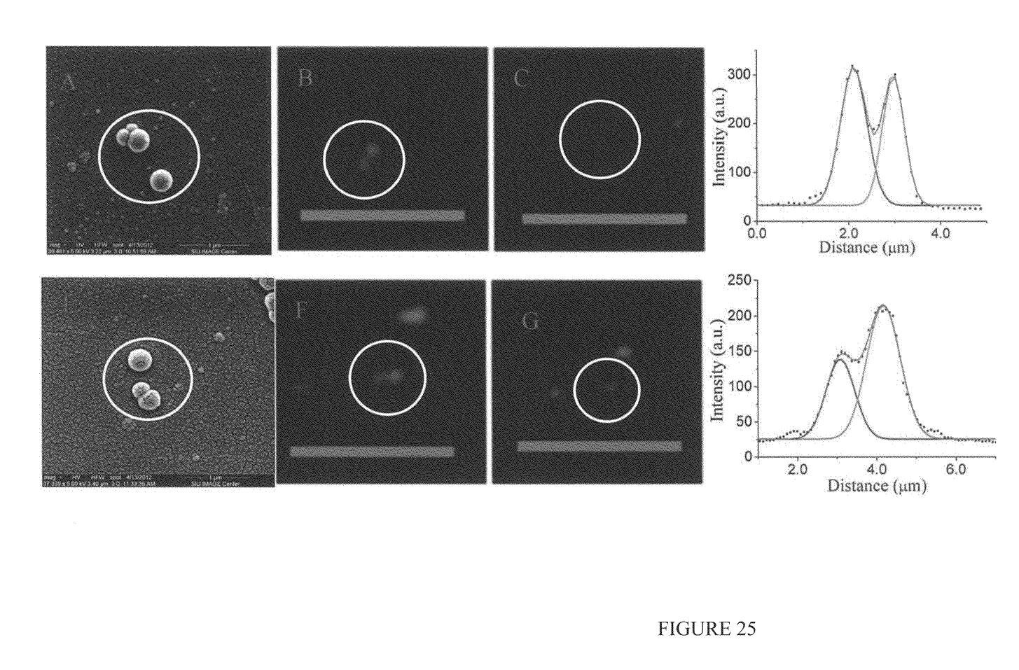

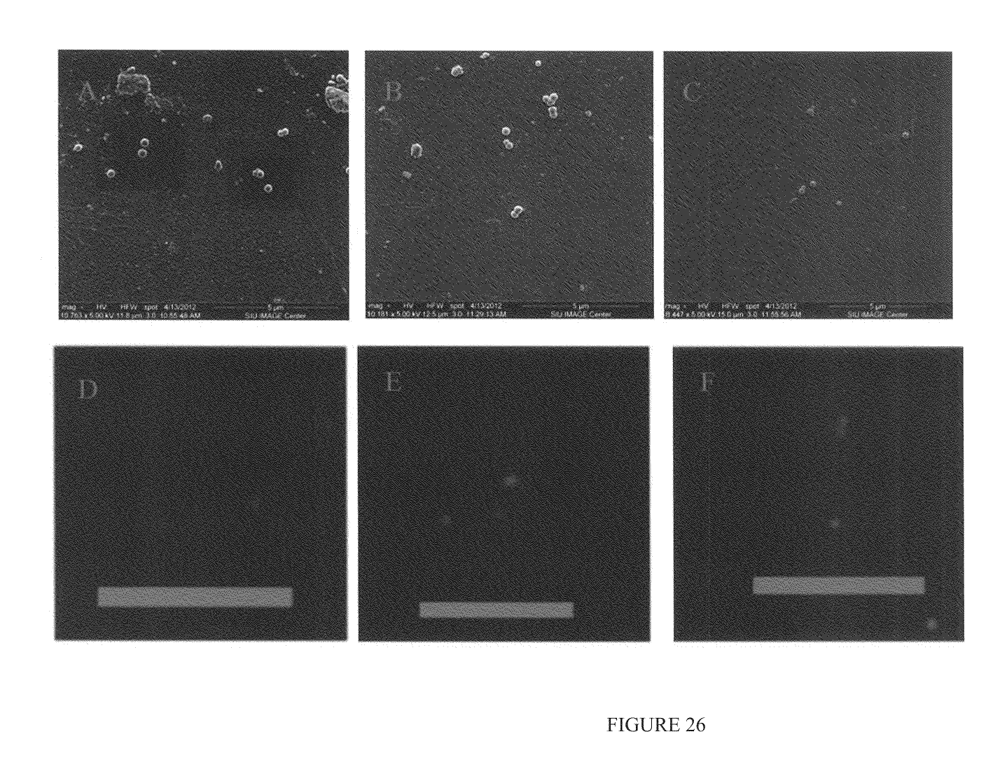

FIG. 24 shows the fluorescent intensity distributions of two groups of nanoparticles presented in FIGS. 7A and 7E. There is only one peak without ML (FIG. 24A and 24C) but two peaks were observed when an ML is used (FIGS. 24A and 24C), indicating the super resolving capability of an ML. It was also found that the emission was greatly enhanced by using an ML. In FIGS. 25A and 25E, the spacing distances between two separated particles are 330 nm and 150 nm respectively. The two separated groups of nanoparticles are fully discerned by using an ML (ZnCl₂, 13 μm) (FIGS. 25C and 25G), but indistinguishable without an ML (FIGS. 25B and 25F). Based on the intensity distribution analysis (FIGS. 25A and 25F), we achieved modifications of 1.53 and 1.7 times and 3.9 and 3.7 times increased in the integral intensities. The spacing distances peak to peak are 0.49 μm and 0.31 μm measured with microscope, respectively, corresponding to a real size of 0.23 μm and 0.22 μm, close to the data got from SEM (330 nm and 283 nm, respectively) (FIGS. 25D and 25H). The fluorescent nanoparticles and corresponding SEM images are shown for positing and confirming (FIG. 26).

The various nanoscopy apparatus examples shown above illustrate a nanoscope design. A user of the present invention may choose any of the above nanoscopy embodiments, or an equivalent thereof, depending upon the desired application. In this regard, it is recognized that various forms of the subject nanoscope could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

The various implementations and examples shown above illustrate a method and system for nanoscopy. A user of the present method and system may choose any of the above implementations, or an equivalent thereof, depending upon the desired application. In this regard, it is recognized that various forms of the subject nanoscopic method and system could be utilized without departing from the spirit and scope of the present implementation.

As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present implementation. Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. For example the image projected by the nanascope may be captured digitally by a sensing device and the resulting digital data can be post processed by a machine such as a computing system. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

The example computer system and client computers include a processor (e.g., a central processing unit (CPU) a graphics processing unit (GPU) or both), a main memory and a static memory, which communicate with each other via a bus. The computer system may further include a video/graphical display unit (e.g., a liquid crystal display (LCD) or a cathode ray tube (CRT)). The computer system and client computing devices also include an alphanumeric input device (e.g., a keyboard), a cursor control device (e.g., a mouse), a drive unit, a signal generation device (e.g., a speaker) and a network interface device.

The drive unit includes a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

Other aspects, objects and advantages of the present invention can be obtained from a study of the drawings, the disclosure and the appended claims.

What is claimed is:

1. A scope device for viewing nanoscopy sized objects comprising:
a microlens having a diameter less than about 30 μm deposited on a glass substrate where the microlens has a convex spherical curvature with respect to the glass substrate and having a refractive index greater than 1.45.

2. The device as recited in claim 1, where the microlens is selected from a group of lenses consisting of a plano-convex lens and a spherical lens;

3. The device as recited in claim 2, where the microlens is a deliquescent salt added liquid plano-convex microlens having a hemispherical convex surface.

4. The device as recited in claim 3, where the deliquescent salt added liquid plano-convex microlens has a long fluorocarbon silane monolayer film deposited on the microlens.

5. The device as recited in claim 3, where the microlens is a glass microsphere.

6. The device as recited in claim 3, where the microlens has a small Fresnel number.

7. The device as recited in claim 1, where the microlens is adjustable positioned above an objective of a microscope and below a specimen tray of a microscope.

8. The device as recited in claim 7, where one of the microlens or specimen tray of the microscope is attached to a piezoelectric stage for positioning the microlens with respect to the specimen tray.

9. The device as recited in claim 8, where the salt microlens is mounted on a piezoelectric stage that can be driven to accomplish the scanning.

10. The device as recited in claim 1, where the glass substrate has multiple microlenses deposited thereon.

11. A method for viewing nanoscopy sized objects comprising the steps of:
resolving an object using a microlens having a diameter less than about 30 μm deposited on a glass substrate where the microlens has a convex spherical curvature with respect to the glass substrate and having a refractive index greater than 1.45.

12. The method as recited in claim 11, where the microlens is selected from a group of lenses consisting of a plano-convex lens and a spherical lens;

13. The method as recited in claim 12, where the microlens is a deliquescent salt added liquid plano-convex microlens having a hemispherical convex surface.

14. The method as recited in claim 13, where the deliquescent salt added liquid plano-convex microlens has a long fluorocarbon silane monolayer film deposited on the microlens.

15. The device as recited in claim 13, where the microlens is a glass microsphere.

16. The method as recited in claim 13, where the microlens has a small Fresnel number.

17. The method as recited in claim 11, where the microlens is adjustable positioned above an objective of a microscope and below a specimen tray of a microscope.

18. The method as recited in claim 17, where one of the microlens or specimen tray of the microscope is attached to a piezoelectric stage for positioning the microlens with respect to the specimen tray.

19. The method as recited in claim 18, where the salt microlens is mounted on a piezoelectric stage that can be driven to accomplish the scanning.

20. The method as recited in claim 1, where the glass substrate has multiple microlenses deposited thereon.

21. The method as recited in claim 1, further comprising the steps of: magnifying a virtual image of the specimen when the distance between microlens and specimen is less than the wavelength of the light (<600 nm) where the virtual image can then be magnified by the microscope and captured by eyes or a CCD camera.
